(19) United States
(12) Patent Application Publication
(10) Pub. No.: US 2020/0021918 A1
(43) Pub. Date: Jan. 16, 2020

(54) Tweeter, Vibration Structure and Inverted Concave Diaphragm Thereof, and Manufacturing Method and Sound Effect Reproduction Method Therefor

(71) Applicant: TANG BAND IND CO., LTD., Ningbo (CN)

(72) Inventor: Hsin Min HUANG, Ningbo (CN)

(21) Appl. No.: 16/465,578

(22) PCT Filed: Dec. 4, 2017
(86) PCT No.: PCT/CN2017/114513

§ 371 Date: Aug. 21, 2019

(30) Foreign Application Priority Data
Dec. 2, 2016 (CN) 201611100305.5

(51) Int. Cl. H04R 9/06; H04R 9/02; H04R 7/12; H04R 7/18; H04R 31/00

(52) U.S. Cl. CPC H04R 9/06; H04R 9/025; H04R 7/127; H04R 2400/11; H04R 31/003; H04R 2231/001; H04R 7/18

(57) ABSTRACT

A tweeter includes a magnet unit, a voice coil, a casing panel; and a vibration unit. The vibration unit includes an inverted diaphragm and a resilient suspension member. The resilient suspension member includes a suspension member body and an inner side connecting edge and an outer side connecting edge integrally extended from the suspension member body respectively, wherein when the inner side connecting edge is integrally coupled to the outer surface of the inverted diaphragm, the outer side connecting edge thereof is integrally coupled to the outer surface of the casing panel. One end of the voice coil is coupled to the inverted concave diaphragm, while the opposing end thereof is coupled with the magnet unit. The tweeter is able to provide a high-pitch voice with a high frequency of 2560 Hz or above, or even 40 kHz or above, to enhance the high-pitch sound effect of the tweeter.

### CROSS REFERENCE OF RELATED APPLICATION

This is a U.S. National Stage under 35 U.S.C. 371 of the International Application Number PCT/CN2017/114513, filed on Dec. 4, 2017, which claims priority to Chinese application number CN201611100305.5, filed Dec. 2, 2016.

### BACKGROUND OF THE PRESENT INVENTION

### Field of Invention

The present invention relates to speaker, and more particularly to a tweeter vibration structure and inverted concave diagram thereof, and their manufacturing and sound effect reproduction methods.

### Description of Related Arts

Sound is an audible wave generated by vibration of substance. The sound propagating through a medium in a frequency ranging between 20 Hz and 20 kHz is recognizable to human ears. Common conventional sound effect devices, such as speakers or tweeters, are transducers or electronic components that are arranged to convert electrical signals into acoustic signals. The conventional sound effect device includes a speaker frame, a vibrating diagram supported by the frame, a voice coil coupled to the vibration diagram, and a magnet unit electromagnetically coupled with the voice coil, wherein the magnet unit induces a reciprocating vibration of the voice coil so as to drive the diaphragm to vibrate, thereby generating sound by agitating the air around the diaphragm. Accordingly, the vibrating diagram is installed at an opening of the speaker frame, and when the voice coil is electromagnetically induced to reciprocatingly vibrate, the reciprocating vibrating voice coil drives the diaphragm to vibrate back and forth thereby agitating the air to generate sound.

A conventional speaker generally further includes a centering spider for supporting a bonding portion between the diaphragm and the voice coil, so as to restrict a movement direction of the voice coil and the diaphragm. Since the centering spider has a relatively larger resilient force, the speed of the diaphragm is usually uneven during operation and the voice coil reciprocatingly vibrates in a nonlinear manner. Once the voice coil fails to vibrate along a central axis of the voice coil (that is offset from the central axis of the voice coil), the inner side of the speaker may be scratched by the voice coil and the protective coating layer on the inner side may be gradually damaged. Furthermore, the centering spider would cause the voice coil to deviate from its central axis and generate a relatively large left and right sway and/or displacement, resulting in a sound impureness. Moreover, due to the existence of the centering spider, the voice coil and the speaker frame should provide a relatively large space therebetween to allow the centering spider, such that the distance between the outer wall of the voice coil and the inner wall of the speaker frame is increased that adversely influences the miniaturization of the speaker.

Further, since the peripheral edge of the diaphragm is not directly contacted with the speaker frame, the conventional tweeter further includes a suspension member connected between the speaker frame and the diaphragm. The resilient suspension member has different adverse influences on frequency response. Apart from its type and structure, the material selection of the suspension member is also a matter of knowledge. Common materials for the suspension member includes cloth, foam and rubber, wherein the foam is disadvantageous in easily getting erosion; the cloth shall be reinforced by adding polymer materials that its manufacturing process becomes more time-consuming and labor-intensive; the rubber suspension member doesn't have the above disadvantages and its damping characteristics is good but the rubber suspension member is relatively expensive. Regardless of the material selection, the assembly of the resilient suspension members to the diaphragm and resilient suspension member is implemented by means of gluing, that is, the resilient suspension member is glued to the diaphragm and the resilient suspension member is glued to the speaker frame. Such assembly process is troublesome and unstable, especially when the resilient suspension member is made of cloth material. In addition, the generation of high-pitch voice in conventional speaker depends on the special material of the diaphragm that expands a high-frequency elongation, which would cause the manufacturing process even more complicated and a higher manufacturing cost. Moreover, since the diaphragm, the resilient suspension member and the speaker frame are coupled with each other by gluing, the resilient suspension member may easily get detached or loosening from the diaphragm and/or the speaker frame, such that the sound effect quality is affected and the reliability and the stability of the speaker is damaged. As it is well known, the tweeter has a relatively higher reciprocating vibration frequency, wherein long-term and high-frequency reciprocating vibration would cause the stability between the resilient suspension member, the diaphragm and the speaker frame deteriorated.

Tweeter is a speaker that is capable of producing high-pitch voice in a high frequency of above 20 kHz. The vibration diagram of the conventional tweeter is a convex diaphragm such as a hemispherical diaphragm, which not only facilitates the high frequency diffusion, but also has a large diaphragm strength which will not easily be deformed during vibration and causes sound distortion. However, the tweeter having the convex diaphragm has many drawbacks. In particular, since the diaphragm of the tweeter is upwardly protruded at a mid-portion thereof and the sound is generated by the air agitation caused by the reciprocating vibration of the diaphragm, the audible wave produced by the tweeter is diffused and disconverged. However, for some tweeters especially the ones applied in head-mounted audio device, the high-pitch audible wave should be converged and gathered. It is obvious that the conventional tweeter having convex diaphragm is unable to converge high-pitch sounds.

### SUMMARY OF THE PRESENT INVENTION

The invention is advantageous in that it provides a tweeter, a vibration structure and inverted concave vibrating-diaphragm thereof, and manufacturing and sound effect reproduction methods therefor, wherein the tweeter is able to provide a better high-frequency sound quality.

Another advantage of the invention is to provide a tweeter, a vibration structure and inverted concave vibrating-diaphragm thereof, and manufacturing and sound effect reproduction methods therefor, wherein the vibration structure produced by injection molding technique enables the tweeter to have a better high-frequency sound quality.

Another advantage of the invention is to provide a tweeter, a vibration structure and inverted concave vibrating-diaphragm thereof, and manufacturing and sound effect reproduction methods therefor, wherein the tweeter is able to produce a high-pitch voice in a high frequency of 2560 Hz or even an ultra high frequency of 40 kHz so as to enhance its high-pitch performance.

Another advantage of the invention is to provide a tweeter, a vibration structure and inverted concave vibrating-diaphragm thereof, and manufacturing and sound effect reproduction methods therefor, wherein the tweeter is able to converge and gather high-pitch voice, such that even a small size mini tweeter can also have a good high-pitch performance.

Another advantage of the invention is to provide a tweeter, a vibration structure and inverted concave diaphragm thereof, and manufacturing and sound effect reproduction methods therefor, wherein the tweeter comprises an inverted concave diaphragm being driven to reciprocatingly vibrate to produce a high-pitch voice which is converged and gathered by the inverted concave diaphragm.

Another advantage of the invention is to provide a tweeter, a vibration structure and inverted concave diaphragm thereof, and manufacturing and sound effect reproduction methods therefor, wherein the tweeter comprises a resilient suspension member encirclingly provided around a peripheral edge of the inverted concave diaphragm, wherein the resilient suspension member enables the inverted concave diaphragm to reciprocatingly vibrate along an axial direction of the tweeter to avoid deviation and offset thereof to provide audible sound, thereby enhancing the sound quality of the tweeter.

Another advantage of the invention is to provide a tweeter, a vibration structure and inverted concave diaphragm thereof, and manufacturing and sound effect reproduction methods therefor, wherein when the inverted concave diaphragm is reciprocatingly vibrating, the resilient suspension member is able to absorb the vibration of the inverted diaphragm so as to reduce the occurrence of resonance, thereby further improving the purity of the high-pitch voice produced by the tweeter.

Another advantage of the invention is to provide a tweeter, a vibration structure and inverted concave diaphragm thereof, and manufacturing and sound effect reproduction methods therefor, wherein the resilient suspension member is integrally formed with the inverted concave diaphragm, such that the manufacturing difficulties of the tweeter can be reduced and the high-pitch sound effect thereof can be enhanced.

Another advantage of the invention is to provide a tweeter, a vibration structure and inverted concave diaphragm thereof, and manufacturing and sound effect reproduction methods therefor, wherein in comparison with the conventional manufacturing process of gluing the vibration diaphragm with the suspension member, there is no need to apply adhesion at the bonding positions of the inverted concave diaphragm before the resilient suspension member is integrally coupled with the inverted concave diaphragm in the present invention, such that the manufacturing process of the tweeter can be simplified, while ensuring the consistency of the bonding positions between the resilient suspension member and the inverted concave diaphragm so as to enhance the high-pitch sound effect of the tweeter.

Another advantage of the invention is to provide a tweeter and vibration structure and inverted concave diaphragm thereof and manufacturing and sound effect reproduction methods, wherein compared with the conventional manufacturing process of coupling the diaphragm with the suspension member by means of adhesion, there is no need to prefabricate or pre-provide the resilient suspension member in the manufacturing process of the tweeter of the present invention since the resilient suspension member is integrally coupled with the inverted concave diaphragm when the resilient suspension member is manufactured, such that the manufacturing cost of the tweeter can be minimized.

Another advantage of the invention is to provide a tweeter and vibration structure and inverted concave diaphragm thereof and manufacturing and sound effect reproduction methods, wherein the tweeter further comprises a speaker frame and the resilient suspension member is integrally coupled to a casing panel of the speaker frame, such that the manufacturing of the tweeter can be further simplified while the high-pitch performance of the tweeter can be enhanced.

Another advantage of the invention is to provide a tweeter and vibration structure and inverted concave diaphragm thereof and manufacturing and sound effect reproduction methods, wherein compared with the conventional manufacturing process of coupling the diaphragm with the suspension member by means of adhesion, there is no need to apply adhesion at the bonding positions of the casing panel before the resilient suspension member is integrally coupled with the casing panel in the manufacturing process of the tweeter of the present invention, such that the manufacturing process of the tweeter can be simplified, while ensuring the consistency of the bonding positions between the resilient suspension member and the casing panel, so as to enhance the high-pitch sound performance of the tweeter.

Another advantage of the invention is to provide a tweeter, a vibration structure and inverted concave diaphragm thereof, and manufacturing and sound effect reproduction methods therefor, wherein in comparison with the conventional manufacturing process of gluing the vibration diaphragm with the suspension member, there is no need to prefabricate or pre-provide the resilient suspension member in the manufacturing process of the tweeter of the present invention since the resilient suspension member is integrally coupled with the casing panel during fabricating the resilient suspension member, such that the manufacturing cost of the tweeter can be further reduced.

Another advantage of the invention is to provide a tweeter, a vibration structure and inverted concave diaphragm thereof, and manufacturing and sound effect reproduction methods therefor, wherein an inner side of the resilient suspension member is integrally coupled to the inverted concave diaphragm while an outer side of the resilient suspension member is integrally coupled to the casing panel to form the vibrating structure having an integral one-piece structure, wherein since the inner side of the resilient suspension member is securely coupled to the inverted concave diaphragm while an outer side of the resilient suspension member is securely coupled to the casing panel, detachment or loosening of the inner side of the resilient suspension member from the inverted concave diaphragm and the outer side of resilient suspension member from the casing panel can be substantially prevented, ensuring the reliability and stability of the tweeter.

Another advantage of the invention is to provide a tweeter, a vibration structure and inverted concave diaphragm thereof, and manufacturing and sound effect reproduction methods therefor, wherein the inverted concave diaphragm of the tweeter has preset parameters that enable the tweeter to provide a high frequency as high as 2560 Hz, even an ultra high frequency of 40 kHz, so as to greatly enhance the high-pitch performance of the tweeter.

Another advantage of the invention is to provide a tweeter, a vibration structure and inverted concave diaphragm thereof, and manufacturing and sound effect reproduction methods therefor, wherein the arc shaped inverted concave diaphragm of the tweeter has an arc height ranging from 5 mm to 7 mm, an arc curvature ranging from 15 mm to 20 mm in such a manner that the high frequency provided by the tweeter can be above 40 kHz, so as to enhance the high-pitch performance of the tweeter.

Another advantage of the invention is to provide a tweeter, a vibration structure and inverted concave diaphragm thereof, and manufacturing and sound effect reproduction methods therefor, wherein a diameter of the tweeter is ranged from 8 mm to 38 mm, facilitating the miniaturization of the size of the tweeter. For example, the tweeter of the present invention is suitable to be applied to a head-mounted audible device, such as a headphone.

Another advantage of the invention is to provide a tweeter, a vibration structure and inverted concave diaphragm thereof, and manufacturing and sound effect reproduction methods therefor, wherein the inverted concave diaphragm does not have any portion protruding toward the outer side of the tweeter, such that there is no need to worry about any accidentally damage to the inverted concave diaphragm, such as being deformed or crashed, during the storage, transportation or installation of the tweeter, so as to ensure the sound quality thereof.

Another advantage of the invention is to provide a tweeter, a vibration structure and inverted concave diaphragm thereof, and manufacturing and sound effect reproduction methods therefor, wherein the inverted concave diaphragm is embodied as an alloyed diaphragm or a metallic diaphragm so as to ensure the rigidity and strength of the inverted concave diaphragm, so as to ensure the sound quality of the tweeter.

Another advantage of the invention is to provide a tweeter, a vibration structure and inverted concave diaphragm thereof, and manufacturing and sound effect reproduction methods therefor, wherein no centering spider is required to be provided at the peripheral edge of the voice coil in the present invention, such that the present invention provides a tweeter having no centering spider that provides a more compact overall structure, a simplified manufacturing process and a lower manufacturing cost. In other words, since no centering supporting element is required in the present invention, a distance between the voice coil and the inner wall of the speaker frame can be greatly decreased to facilitate miniaturization in size of the tweeter.

Additional advantages and features of the invention will become apparent from the description which follows, and may be realized by means of the instrumentalities and combinations particular point out in the appended claims.

According to the present invention, the foregoing and other objects and advantages are attained by a tweeter, comprising:

a magnet unit;

a voice coil;

a speaker casing which comprises a casing panel;

a vibration unit, which comprises an inverted concave diaphragm and a resilient suspension member, wherein the resilient suspension member comprises a suspension member body, an inner side connecting edge integrally extended from an inner side of the suspension member body, and an outer side connecting edge integrally extended from an outer side of the suspension member body, wherein when the inner side connecting edge of the resilient suspension member is integrally coupled to at least a portion of a surface of the inverted concave diaphragm, the outer side connecting edge of the resilient suspension member is integrally coupled to at least a portion of a surface of the casing panel, wherein one end of the voice coil is coupled to the inverted concave diaphragm while an opposing end of the voice coil is coupled to the magnet unit.

In one embodiment of the present invention, the casing panel has an engaging groove, wherein the outer side connecting edge of the resilient suspension member is formed at the engaging groove of the casing panel.

In one embodiment of the present invention, the casing panel has one or more engaging through holes, wherein each of the engaging through holes is communicated with the engaging groove, wherein the resilient suspension member comprises at least one suspension member engaging portion integrally extended from the outer side connecting edge of the resilient suspension member, wherein the suspension member engaging portions are integrally formed at the engaging through holes of the casing panel respectively.

In one embodiment of the present invention, the casing panel has a retention slot commutating with at least one of the engaging through holes, wherein the resilient suspension member comprises a suspension member retention portion integrally formed with the suspension member engaging portion, wherein the suspension member retention portion is formed in the retention slot of the casing panel.

In one embodiment of the present invention, the inner side connecting edge of the resilient suspension member is integrally coupled with at least a portion of the upper surface of the inverted concave diaphragm, and/or the inner side connecting edge of the resilient suspension member is integrally coupled with at least a portion of the lower surface of the inverted concave diaphragm.

In one embodiment of the present invention, the resilient suspension member further comprises a plurality of resilient ribs, wherein each of the resilient ribs is protrudedly formed at the suspension member body of the resilient suspension member and extended in a direction from the inner side connecting edge to the outer side connecting edge.

In one embodiment of the present invention, the resilient suspension member further comprises a plurality of resilient ribs, wherein each of the resilient ribs is intendedly formed at the suspension member body of the resilient suspension member and extended in a direction from the inner side connecting edge to the outer side connecting edge.

In one embodiment of the present invention, the resilient suspension member further comprises a plurality of resilient ribs, wherein each of the resilient ribs is formed at the suspension member body of the resilient suspension member and two resilient ribs intendedly formed at the suspension member body of the resilient suspension member are respectively provided at two sides of one resilient rib protrudedly formed at the suspension member body of the resilient suspension member.

In one embodiment of the present invention, the resilient suspension member further comprises a set of inner resilient ribs and a set of outer resilient rib, wherein each of the inner resilient ribs is extended from the inner side connecting edge to the outer side connecting edge of, while each of the outer resilient ribs is extended from the outer side connecting edge to the inner side connecting edge, wherein each of the inner resilient ribs is extended between two adjacent outer resilient ribs, while each of the outer resilient ribs is extended between two adjacent inner resilient ribs.

In one embodiment of the present invention, the inverted concave diaphragm comprises a concave diaphragm portion and a diaphragm coupling portion integrally and encirclingly formed around a peripheral edge of the concave diaphragm portion, wherein the inner side connecting edge of the resilient suspension member is integrally coupled with the diaphragm coupling portion of the inverted concave diaphragm.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R ranging between 10 mm-15 mm (10 mm≤R≤15 mm) or between 15 mm-20 mm (15 mm≤R≤20 mm).

In one embodiment of the present invention, the inverted concave diaphragm is a metal vibrating diaphragm or an alloy vibrating diaphragm.

In one embodiment of the present invention, the magnet unit is installed to the casing panel.

In one embodiment of the present invention, the speaker casing further includes a back case which is coupled to the casing panel, wherein the magnet unit and the voice coil are arranged in the space formed between the casing panel and the back case.

In one embodiment of the present invention, the diameter of the tweeter is ranged between 8 mm-38 mm.

According to another aspect of the present invention, it further provides a sound effect reproduction method of a tweeter, comprising the following steps.

(a) Generate a magnetic driving force to drive a voice coil to vibrate reciprocatingly along an axial direction of the tweeter.

(13) Drive the inverted concave diaphragm by the voice coil to vibrate reciprocatingly along the axial direction of the tweeter so as to agitate air therearound to produce and gather high frequency sound waves to reproduce the sound effect.

In one embodiment of the present invention, in the step (13), the reciprocating movement of the inverted concave diaphragm is restricted to the forwards and backwards along the axial direction of the tweeter by a resilient suspension member which is integrally coupled to the inverted concave diaphragm and encirclingly coupled to a peripheral edge of the casing panel.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R between 10 mm-15 mm (10 mm≤R≤15 mm) or between 15 mm-20 mm (15 mm≤R≤20 mm).

In one embodiment of the present invention, the diameter of the tweeter is ranged from 8 mm-38 mm.

According to another aspect of the present invention, it further provides a manufacturing method of a tweeter, comprising the following steps.

(I) Dispose an inverted concave diaphragm and an casing panel in a lower mould of a molding mould, such as an injection mould, at a position that the inverted concave diaphragm is positioned at a middle portion of a ring shaped casing panel in such a manner that an annular space is formed between the casing panel and the inverted concave diaphragm.

(II) Enclose the lower mould with an upper mould of the molding mould to form a molding cavity between the lower mould and the upper mould and at least one gap, communicating with the molding cavity, between at least a portion of the inverted concave diaphragm and a portion of the casing panel with the upper mould and/or the lower mould.

(III) Fill a fluid state molding material into the molding cavity and the at least one gap.

(IV) After the molding material is cured and solidified in the molding mould, separate the upper mould and the lower mould of the molding mould and a resilient suspension member is formed between the inverted concave diaphragm and the casing panel and integrally coupled with the inverted concave diaphragm and the casing panel.

(V) Mount one end of a voice coil to a lower portion of the inverted concave diaphragm and couple an opposing end of the voice coil to a magnet unit to form the tweeter.

In one embodiment of the present invention, in the step (III), the molding material is filled into the gap formed between an engaging groove of the casing panel and the upper mould, such that, in the step (IV), an outer side connecting edge of the resilient suspension member is formed in the engaging groove of the casing panel while integrally coupling to the casing panel.

In one embodiment of the present invention, in the step (III), the molding material is filled into at least one engaging through hole of the casing panel, such that, in the step (IV), at least one suspension member engaging portion of the resilient suspension member is integrally extended from an outer side connecting edge of the resilient suspension member and formed in the at least one engaging through hole of the casing panel.

In one embodiment of the present invention, in the step (III), the molding material is filled into the gap between a retention slot of the casing panel and the lower mould, such that, in the step (IV), a suspension member retention portion of the resilient suspension member is formed in the retention slot of the casing panel while integrally coupling to the suspension member engaging portion of the resilient suspension member.

In one embodiment of the present invention, in the step (III), the molding material is filled into the gap formed between an upper surface of the inverted concave diaphragm and the upper mould, such that, in the step (IV), an inner side connecting edge is integrally formed at the upper surface of the inverted concave diaphragm while integrally coupling to the inverted concave diaphragm.

In one embodiment of the present invention, in the step (III), the molding material is filled into the gap formed between a lower surface of the inverted concave diaphragm and the lower mould, such that, in the step (IV), an inner side connecting edge is integrally formed at the lower surface of the inverted concave diaphragm while integrally coupling to the inverted concave diaphragm.

In one embodiment of the present invention, in the step (III), the molding material is filled into the gap formed between an upper surface of the inverted concave diaphragm and the upper mould as well as the gap between a lower surface of the inverted concave diaphragm and the lower mould, such that, in the step (IV), an inner side connecting edge is integrally formed at both the upper surface and the lower surface of the inverted concave diaphragm while integrally coupling to the inverted concave diaphragm.

In one embodiment of the present invention, the inverted concave diaphragm comprises a concave diaphragm portion and a diaphragm coupling portion integrally and surroudingly formed around a peripheral edge of the concave diaphragm portion, wherein in the step (IV), an inner side connecting edge of the resilient suspension member is integrally coupled to the diaphragm coupling portion of the inverted concave diaphragm.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

According to another aspect of the present invention, it further provides a manufacturing method of a tweeter, comprising the following steps.

(i) Solidify a fluid state molding material to from a resilient suspension member between an inverted concave diaphragm and a casing panel.

(ii) Mount one end of a voice coil to a lower portion of the inverted concave diaphragm and couple an opposing end of the voice coil to a magnet unit so as to produce the tweeter, wherein the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R from 10 mm-15 mm (10 mm≤R≤15 mm) or between 15 mm-20 mm (15 mm≤R≤20 mm).

According to another aspect of the present invention, it further provides a manufacturing method of a vibrating structure, comprising the following steps.

(a) Dispose an inverted concave diaphragm and an casing panel in a lower mould of a molding mould, such as an injection mould, at a position that the inverted concave diaphragm is positioned at a middle portion of a ring shaped casing panel in such a manner that an annular space is formed between the casing panel and the inverted concave diaphragm.

(b) Enclose the lower mould with an upper mould of the molding mould to form a molding cavity between the lower mould and the upper mould and at least one gap, communicating with the molding cavity, between at least a portion of the inverted concave diaphragm and a portion of the casing panel with the upper mould and/or the lower mould.

(c) Fill a fluid state molding material into the molding cavity and the at least one gap.

(d) After the molding material is cured and solidified in the molding mould, separate the upper mould and the lower mould of the molding mould and a resilient suspension member is formed between the inverted concave diaphragm and the casing panel and integrally coupled with the inverted concave diaphragm and the casing panel.

In one embodiment of the present invention, in the step (c), the molding material is filled into the gap formed between an engaging groove of the casing panel and the upper mould, such that, in the step (d), an outer side connecting edge of the resilient suspension member is formed in the engaging groove of the casing panel while integrally coupling to the casing panel.

In one embodiment of the present invention, in the step (c), the molding material is filled into at least one engaging through hole of the casing panel, such that, in the step (d), at least one suspension member engaging portion of the resilient suspension member is integrally extended from an outer side connecting edge of the resilient suspension member and formed in the at least one engaging through hole of the casing panel.

In one embodiment of the present invention, in the step (c), the molding material is filled into the gap between a retention slot of the casing panel and the lower mould, such that, in the step (d), a suspension member retention portion of the resilient suspension member is formed in the retention slot of the casing panel while integrally coupling to the suspension member engaging portion of the resilient suspension member.

In one embodiment of the present invention, in the step (c), the molding material is filled into the gap formed between an upper surface of the inverted concave diaphragm and the upper mould, such that, in the step (d), an inner side connecting edge is integrally formed at the upper surface of the inverted concave diaphragm while integrally coupling to the inverted concave diaphragm.

In one embodiment of the present invention, in the step (c), the molding material is filled into a diaphragm engaging slot of the inverted concave diaphragm, such that, in the step (d), at least a portion of an inner side connecting edge is formed in the diaphragm engaging slot of the inverted concave diaphragm.

In one embodiment of the present invention, in the step (c), the molding material is filled into the gap formed between a lower surface of the inverted concave diaphragm and the lower mould, such that, in the step (d), an inner side connecting edge is integrally formed at the lower surface of the inverted concave diaphragm while integrally coupling to the inverted concave diaphragm.

In one embodiment of the present invention, in the step (c), the molding material is filled into the gap formed between an upper surface of the inverted concave diaphragm and the upper mould as well as the gap between a lower surface of the inverted concave diaphragm and the lower mould, such that, in the step (d), an inner side connecting edge is integrally formed at both the upper surface and the lower surface of the inverted concave diaphragm while integrally coupling to the inverted concave diaphragm.

In one embodiment of the present invention, the inverted concave diaphragm comprises a concave diaphragm portion and a diaphragm coupling portion integrally and surroudingly formed around a peripheral edge of the concave diaphragm portion, wherein in the step (d), an inner side connecting edge of the resilient suspension member is integrally coupled to the diaphragm coupling portion of the inverted concave diaphragm.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

According to another aspect of the present invention, it further provides a manufacturing method of a vibrating structure, comprising the following steps.

(A) Fill a fluid state molding material into a formation mould, such as an injection formation mould, to cover at least a portion of a surface of a casing panel and at least a portion of an outer surface of an inverted concave diaphragm, and to fill an annular space formed between an inner side of the casing panel and an outer side of the inverted concave diaphragm.

(B) Solidify the molding material to form an outer side connecting edge by the molding material covering the surface of the casing panel, an inner side connecting edge by the molding material covering the inverted concave diaphragm, and a suspension member body by the molding material in the annular space, wherein the suspension member body, the outer side connecting edge integrally extended from the suspension member body, and the inner side connecting edge integrally extended from the suspension member body are integrally coupled to form a resilient suspension member while integrally coupling with the inverted concave diaphragm and the casing panel, so as to produce the vibrating structure.

In one embodiment of the present invention, in the step (A), an upper surface of the casing panel has an engaging slot formed for filling with the molding material to cover the upper surface of the casing panel, such that, in the step (B), the outer side connecting edge of the resilient suspension member is formed in the engaging slot of the casing panel after the solidification of the molding material.

In one embodiment of the present invention, in the step (A), the casing panel has at least one engaging through hole penetrating through an upper surface and a lower surface of the casing panel for enabling the molding material to flow in and fill the at least one engaging through hole, such that, in the step (B) at least one suspension member engaging portion of the resilient suspension member is integrally formed in the at least one engaging through hole of the casing panel while integrally extending from the outer side connecting edge after the solidification of the molding material.

In one embodiment of the present invention, in the step (A), the casing panel has a retention slot formed at a lower surface thereof for enabling the molding material to flow and fill in, such that in the step (B), a suspension member retention portion of the resilient suspension member is formed in the retention slot of the casing panel while integrally extending from the inner side connecting edge after the solidification of the molding material.

In one embodiment of the present invention, a gap is formed between a upper surface of the inverted concave diaphragm and the upper mould for guiding the molding material to cover the upper surface of the inverted concave diaphragm, such that, in the step (B), an inner side connecting edge is integrally formed at the upper surface of the inverted concave diaphragm while integrally coupling to the inverted concave diaphragm after the solidification of the molding material.

In one embodiment of the present invention, in the step (A), a gap is formed between a lower surface of the inverted concave diaphragm and the lower mould for guiding the molding material to cover the lower surface of the inverted concave diaphragm, such that, in the step (B), an inner side connecting edge is integrally formed at the lower surface of the inverted concave diaphragm while integrally coupling to the inverted concave diaphragm after the solidification of the molding material.

In one embodiment of the present invention, in the step (A), one or more gaps are formed between the upper surface of the inverted concave diaphragm and the upper mould as well as between the lower surface of the inverted concave diaphragm and the upper mould for guiding the molding material to cover the upper surface and the lower surface of the inverted concave diaphragm, such that, in the step (B), an inner side connecting edge is integrally formed at the upper surface and the lower surface of the inverted concave diaphragm while integrally coupling to the inverted concave diaphragm after the solidification of the molding material.

In one embodiment of the present invention, the inverted concave diaphragm comprises a concave diaphragm portion and a diaphragm coupling portion integrally and surroundingly formed at a peripheral edge of the concave diaphragm portion, wherein in the step (B), an inner side connecting edge of the resilient suspension member is integrally coupled to the diaphragm coupling portion of the inverted concave diaphragm.

In one embodiment of the present invention, the inverted concave diaphragm comprises a concave diaphragm portion and a diaphragm coupling portion integrally and surroundingly formed at a peripheral edge of the concave diaphragm portion, wherein in the step (B), an inner side connecting edge of the resilient suspension member is integrally coupled to the diaphragm coupling portion of the inverted concave diaphragm.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

According to another aspect of the present invention, it further provides a vibrating structure, comprising:

a casing panel;

an inverted concave diaphragm; and

a resilient suspension member, wherein the resilient suspension member has a ring shape and comprises a suspension member body, an inner side connecting edge and an outer side connecting edge integrally extended from an inner side and an outer side of the suspension member body respectively, wherein when the inner side connecting edge of the resilient suspension member is integrally coupled to at least a portion of a surface of the inverted concave diaphragm, the outer side connecting edge of the resilient suspension member is integrally coupled to at least a portion of a surface of the casing panel.

In one embodiment of the present invention, the casing panel has an engaging groove, wherein the outer side connecting edge of the resilient suspension member is integrally formed at the engaging groove of the casing panel.

In one embodiment of the present invention, the casing panel has at least one engaging through hole communicating with the engaging groove, wherein the resilient suspension member comprises at least one suspension member engaging portion integrally extended from the outer side connecting edge thereof, wherein the at least one suspension member engaging portion is integrally formed at the at least one engaging through hole of the casing panel.

In one embodiment of the present invention, the casing panel has a retention slot commutating with the at least one engaging through hole, wherein the resilient suspension member comprises at least one suspension member retention portion integrally formed with the at least one suspension member engaging portion, wherein the suspension member retention portion is formed in the retention slot of the casing panel.

In one embodiment of the present invention, the inner side connecting edge of the resilient suspension member is integrally coupled to at least a portion of an upper surface of the inverted concave diaphragm.

In one embodiment of the present invention, the inner side connecting edge of the resilient suspension member is integrally coupled to at least a portion of a lower surface of the inverted concave diaphragm.

In one embodiment of the present invention, the inner side connecting edge of the resilient suspension member is integrally coupled to at least a portion of the upper surface of the inverted concave diaphragm and to at least a portion of the lower surface of the inverted concave diaphragm.

In one embodiment of the present invention, the resilient suspension member further comprises a plurality of resilient ribs, wherein each of the resilient ribs is protrudedly formed at the suspension member body of the resilient suspension member and extended in a direction from the inner side connecting edge to the outer side connecting edge of the resilient suspension member.

In one embodiment of the present invention, the resilient suspension member further comprises a plurality of resilient ribs, wherein each of the resilient ribs is intendedly formed at the suspension member body of the resilient suspension member and extended in a direction from the inner side connecting edge to the outer side connecting edge of the resilient suspension member.

In one embodiment of the present invention, the resilient suspension member further comprises a plurality of resilient ribs, wherein two of the resilient ribs intendedly formed at the suspension member body of the resilient suspension member are provided at two sides of one respective resilient rib protrudedly formed at the suspension member body of the resilient suspension member.

In one embodiment of the present invention, the resilient suspension member further comprises a set of inner resilient ribs and a set of outer resilient rib, wherein each of the inner resilient ribs is extended in a direction from the inner side connecting edge to the outer side connecting edge of the resilient suspension member, while each of the outer resilient ribs is extended in a direction from the outer side connecting edge to the inner side connecting edge of the resilient suspension member, wherein each of the inner resilient ribs is extended between two adjacent outer resilient ribs, while each of the outer resilient ribs is extended between two adjacent inner resilient ribs.

In one embodiment of the present invention, the inverted concave diaphragm comprises a concave diaphragm portion and a diaphragm coupling portion integrally and surroundingly formed at a peripheral edge of the concave diaphragm portion, wherein the inner side connecting edge of the resilient suspension member is integrally coupled to the diaphragm coupling portion of the inverted concave diaphragm.

In one embodiment of the present invention, the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R between 10 mm-15 mm (10 mm≤R≤15 mm) or between 15 mm-20 mm (15 mm≤R≤20 mm).

According to another aspect of the present invention, it further provides a vibrating structure, comprising:

a resilient suspension member; and

an inverted concave diaphragm integrally coupled with the resilient suspension member, wherein the inverted concave diaphragm comprises a concave diaphragm portion and a diaphragm coupling portion integrally, encirclingly and surroundingly formed at a peripheral edge of the concave diaphragm portion, wherein the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R between 10 mm-15 mm (10 mm≤R≤15 mm) or between 15 mm-20 mm (15 mm≤R≤20 mm).

In one embodiment of the present invention, the resilient suspension member is integrally coupled to the diaphragm coupling portion of the inverted concave diaphragm.

In one embodiment of the present invention, the resilient suspension member is integrally coupled to the diaphragm coupling portion at an upper surface thereof, or the resilient suspension member is integrally coupled to the diaphragm coupling portion at a lower surface thereof, or the resilient suspension member is integrally coupled to a lower surface and an upper surface of the diaphragm coupling portion.

In one embodiment of the present invention, the vibrating structure comprises a concave diaphragm portion, wherein the concave diaphragm portion of the inverted concave diaphragm has an arc height H ranging between 5 mm-7 mm (5 mm≤H≤7 mm), and an arc curvature R ranging between 10 mm-20 mm (10 mm≤R≤20 mm).

In one embodiment of the present invention, the concave diaphragm portion of the inverted concave diaphragm has an arc height H ranging between 5.5 mm-6.5 mm (5.5 mm≤H≤6.5 mm), and an arc curvature R between 10 mm-15 mm (10 mm≤R≤15 mm) or between 15 mm-20 mm (15 mm≤R≤20 mm).

In one embodiment of the present invention, the inverted concave diaphragm further comprises a diaphragm coupling portion integrally, surroundingly and encirclingly formed at a peripheral edge of the concave diaphragm portion.

In one embodiment of the present invention, the inverted concave diaphragm is embodied as a metallic vibrating diaphragm or alloy vibrating diaphragm.

According to another aspect of the present invention, it further provides a tweeter, comprising:

at least one vibrating unit, wherein the at least one vibrating unit comprises at least one inverted concave diaphragm and at least one ring-shaped resilient suspension member, wherein the resilient suspension member formed by injection molding is integrally and surroundingly coupled to the inverted concave diaphragm;

at least one magnet unit;

at least one voice coil, wherein one end of the voice coil is coupled to the inverted concave diaphragm while an opposing end of the voice coil is coupled to the magnet unit; and

a speaker casing coupled to the vibrating unit, wherein the voice coil and the magnet unit are received in the speaker casing.

In one embodiment of the present invention, the speaker casing comprises a casing panel, wherein the resilient suspension member is formed by injection molding and integrally coupled to the casing panel.

In one embodiment of the present invention, the speaker casing comprises at least one connecting frame, wherein the resilient suspension member is formed by injection molding and integrally coupled to the inverted concave diaphragm and the connecting frame.

In one embodiment of the present invention, the speaker casing comprises at least one back cover coupled with the casing panel for receiving the vibrating unit, the voice coil, and the magnet unit therebetween.

In one embodiment of the present invention, the speaker casing comprises at least one back cover coupled with the casing panel, wherein the connecting frame is engaged with the casing panel.

In one embodiment of the present invention, the casing panel has at least one engaging groove, wherein the resilient suspension member comprises at least one connecting edge, wherein the resilient suspension member is formed by injection molding, the at least one connecting edge is received in the at least one engaging groove at an outer surface of the casing panel, such that the resilient suspension member is secured to the casing panel.

In one embodiment of the present invention, the casing panel has at least one ring-shaped positioning tongue, each having an engaging slot, wherein the back cover has at least one engaging hood, each having at least one ring-shaped positioning groove, wherein when the casing panel is assembled with the back cover, the ring-shaped positioning tongue is inserted into the ring-shaped positioning groove and the engaging hook is engaged into the engaging slot.

In one embodiment of the present invention, the casing panel has a plurality of first positioning slots and the connecting frame comprises a plurality of connecting positioning tongues engaged with the first positioning slots respectively.

In one embodiment of the present invention, the inverted concave diaphragm has an inverted concave arc shape with an arc height H ranging between 5 mm-7 mm (5 mm≤H≤7 mm), and an arc curvature R ranging between 10 mm-20 mm (10 mm≤R≤20 mm).

In one embodiment of the present invention, the diameter of the tweeter is ranged between 8 mm-38 mm.

In one embodiment of the present invention, the inverted concave diaphragm is made of metallic material.

In one embodiment of the present invention, the magnet unit comprises at least one magnet protective enclosure, at least one permanent magnet and at least one magnetizer, wherein the permanent magnet is positioned below the magnetizer and disposed within the magnet protective enclosure, wherein a magnetic gap is formed between the permanent magnet and the magnet protective enclosure.

In one embodiment of the present invention, the magnet unit is assembled by means of adhesion or by injection molding to form an integrated structure.

In one embodiment of the present invention, the magnet unit further comprises a magnet connecting frame provided between the magnet protective enclosure and the casing panel.

In one embodiment of the present invention, the magnet connecting frame has a plurality of positioning slots and the casing panel comprises a plurality of positioning tongues slidably engaged with into the positioning slots respectively, so as to assemble the casing panel with the magnet connecting frame.

In one embodiment of the present invention, the casing panel comprises at least one first protrusion and the magnet protective enclosure comprises at least one indented slot, wherein when the magnet protective enclosure is coupled with the casing panel, the first protrusion is engaged with the indented slot.

In one embodiment of the present invention, the tweeter further comprises a protective cover provided on top of the casing panel of the speaker casing, for protecting the inverted concave diaphragm and resilient suspension member of the vibrating unit.

In one embodiment of the present invention, the resilient suspension member comprises a plurality of resilient ribs intervally and spacedly arranged around the resilient suspension member in a spiral manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a tweeter according to a first preferred embodiment of the present invention.

FIG. 2 is a front view of the tweeter according to the first preferred embodiment of the present invention.

FIG. 3 is a sectional view of the tweeter, from the A-A line as shown the FIG. 2, according to the first preferred embodiment of the present invention.

FIG. 4 is a perspective view of the tweeter, from the A-A line as shown the FIG. 2, according to the first preferred embodiment of the present invention.

FIG. 5 is an exploded view of the tweeter according to the first preferred embodiment of the present invention.

FIG. 6 is a perspective of a tweeter according to a second preferred embodiment of the present invention.

FIG. 7 is a front view of the tweeter according to the second preferred embodiment of the present invention.

FIG. 8 is a sectional view of the tweeter, from the B-B line as shown the FIG. 7, according to the second preferred embodiment of the present invention.

FIG. 9 is a perspective view of the tweeter, from the B-B line as shown the FIG. 7, according to the second preferred embodiment of the present invention.

FIG. 10 is an exploded view of the tweeter according to the second preferred embodiment of the present invention.

FIG. 11 is a diagram illustrating a LMS test result of the tweeter according to the first preferred embodiment of the present invention.

FIG. 12 is a perspective view of a tweeter according to a third preferred embodiment of the present invention.

FIG. 13 is a perspective view of the tweeter, from the C-C line as shown in the FIG. 12, according to the third preferred embodiment of the present invention.

FIG. 14 is a partial enlarged view of the tweeter, at the position C as shown in the FIG. 13, according to the third preferred embodiment of the present invention.

FIG. 15 is a perspective diagram illustrating a step of the manufacturing process of the tweeter according to the above preferred embodiments of the present invention.

FIG. 16 is a perspective diagram illustrating another step of the manufacturing process of the tweeter according to the above preferred embodiments of the present invention.

FIG. 17 is a perspective diagram illustrating another step of the manufacturing process of the tweeter according to the above preferred embodiments of the present invention.

FIG. 18 is a perspective diagram illustrating another step of the manufacturing process of the tweeter according to the above preferred embodiments of the present invention.

FIG. 19 is a perspective diagram illustrating another step of the manufacturing process of the tweeter according to the above preferred embodiments of the present invention.

FIG. 20 is a perspective diagram illustrating another step of the manufacturing process of the tweeter according to the above preferred embodiments of the present invention

FIG. 21 is a perspective view of the tweeter according to an alternative mode of the above preferred embodiments of the present invention.

FIG. 22 is a perspective view of the tweeter according to another alternative mode of the above preferred embodiments of the present invention.

FIG. 23 is a perspective view of the tweeter according to another alternative mode of the above preferred embodiments of the present invention.

FIG. 24 is a perspective view of the tweeter according to another alternative mode of the preferred embodiments of the present invention.

FIG. 25 is a perspective view of the tweeter according to another alternative mode of the above preferred embodiments of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

As it is well known that a speaker frequency ranging from 2560 Hz to 5120 Hz is defined as high frequency and above 5120 Hz is defined as ultra-high frequency. Accordingly, the speaker provided in the present invention is adapted for providing a frequency band above 2650 Hz and thus the speaker in the present invention is defined as a tweeter.

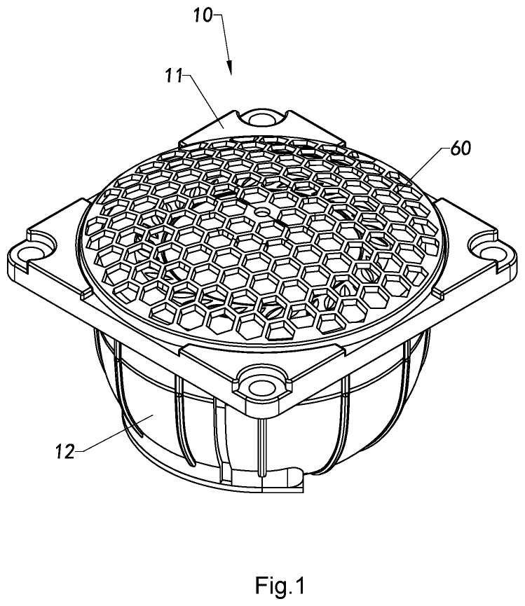

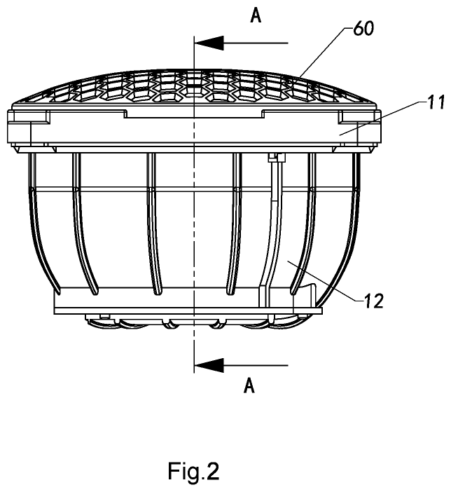

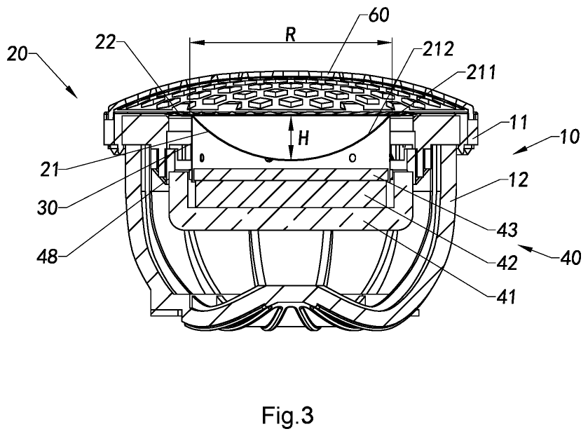

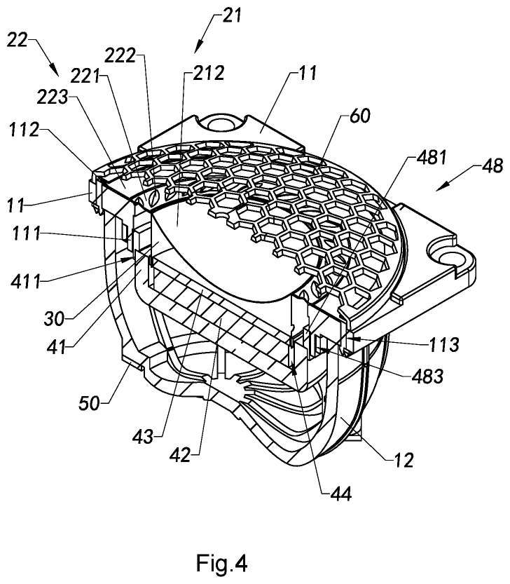

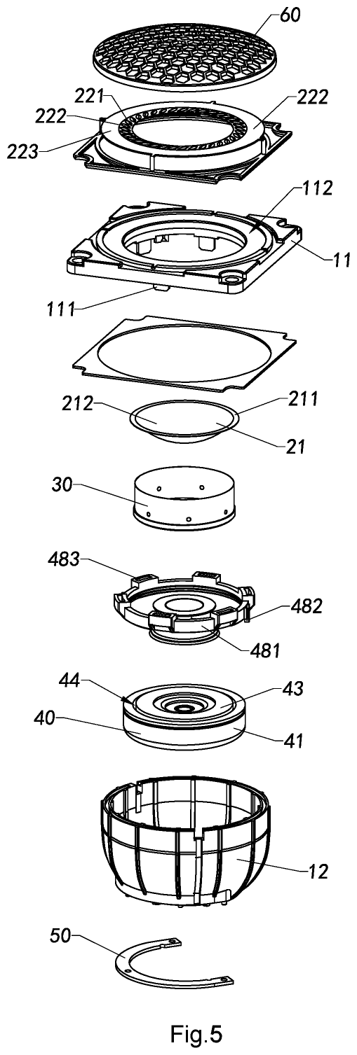

Referring to the FIGS. 1 to 5 of the drawings, a tweeter according to a first preferred embodiment of the present invention is illustrated, wherein the vibrating diaphragm structure and manufacturing process of the tweeter ensuring high quality that reduces not only its manufacturing cost but also its manufacturing procedures while enhancing the quality of its manufacturing process. Accordingly, the tweeter comprises a speaker casing 10, a vibrating unit 20, a voice coil 30, and a magnet unit 40, wherein the vibrating unit 20, the voice coil 30 and the magnet unit 40 are received in the speaker casing 10. More specially, the vibrating unit 20 is provided in the speaker casing 10, wherein an end portion of the voice coil 30 is coupled to the vibrating unit 20 and an opposing end of the voice coil 30 is coupled to the magnet unit 40. In other words, the vibrating unit 20, the voice coil 30 and the magnet unit 40 are installed in the speaker casing 10 that the voice coil 30 is located between the vibrating unit 20 and the magnet unit 40. It is worth mentioning that, during operation, the voice coil 30 is driven to reciprocatingly move back and forth by a electromagnetic driving force provided by the magnet unit 40 to actuate the vibrating unit 20 to reciprocatingly move back and forth along an axial direction thereof, such that the vibrating unit 20 is able to agitate the air in and around the tweeter to produce sound waves.

According to this preferred embodiment of the present invention, the speaker casing 10 comprises a casing panel 11 and a back cover 12 sealedly coupled with the casing panel 11 to receive the vibrating unit 20, the voice coil 30 and the magnet unit 40 therein. In other words, the vibrating unit 20, the voice coil 30 and the magnet unit 40 are received and retained in a cavity defined between the casing panel 11 and the back cover 12. It is appreciated that the casing panel 11 and the back cover 12 can be coupled with each other by various means, including, but not limited to, by means of latch and lock assembly, threaded connecting structure, hot welding, ultrasonic bonding, and etc. According to the tweeter as illustrated in the preferred embodiment of the present invention, the casing panel 11 of the speaker casing 10 can be regarded as an upper casing, and the back cover 12 of the speaker casing 10 can be regarded a lower casing.

According to the preferred embodiment of the present invention, the vibrating unit 20 comprises an inverted concave diaphragm 21 and a resilient suspension member 22 integrally coupled with the inverted concave diaphragm 21. Preferably, the resilient suspension member 22 is integrally coupled with the casing panel 11 and the inverted concave diaphragm 21 which is embodied as a vibrating diaphragm to be driven forth and back along its axial direction by the voice coil 30. In particular, the resilient suspension member 22 is positioned between and integrally coupled with the inverted concave diaphragm 21 and the casing panel 11 during the resilient suspension member 22 is fabricated by injection molding. In other words, by means of the injection molding of the resilient suspension member 22, the resilient suspension member 22, the inverted concave diaphragm 21 and the casing panel 11 are integrated with each other as a one-piece structure to form a vibrating structure 200 of the tweeter, wherein the vibrating structure 200 is an integral body. It is appreciated that the vibrating structure 200 having one-piece structure ensures the bonding consistency at every bonding position between the resilient suspension member 22 and the inverted concave diaphragm 21, such that the high-pitch sound effect of the tweeter can be enhanced while the resilient suspension member 22 ensures the inverted concave diaphragm 21 to reciprocatingly move back and forth along its axial direction of the tweeter without any deviation. Accordingly, the resilient suspension member 22 is fabricated by injection molding that, in the manufacturing process, the casing panel 11 and the back cover 12 are disposed in an injection formation mould, and then a molding material in heated liquid form for making the resilient suspension member 22 is filled into the formation mould, wherein the molding material will attach to the casing panel 11 and the back cover 12 to form the resilient suspension member 22 between the casing panel 11 and the inverted concave diaphragm 21 after the molding material is cooled down and solidified, so that the resilient suspension member 22 is able to integrate the casing panel 11 and the inverted concave diaphragm 21 together to form a one-piece component.

Further, one end of the voice coil 30 is coaxially coupled to the inverted concave diaphragm 21 of the vibrating unit 20, while the opposing end of the voice coil 30 is coupled to the magnet unit 40, such that when the voice coil 30 is actuated to reciprocatingly move back and forth by a magnetic driving force generated by the magnet unit 40, the inverted concave diaphragm 21 and the resilient suspension member 22 of the vibrating unit 20 are being driven to reciprocatingly move back and forth along the axial direction of the inverted concave diaphragm to provide sound in high frequency. It is appreciated that the resilient suspension member 22 restricts the movement of the inverted concave diaphragm 21 merely in its axial direction, that is the inverted concave diaphragm 21 only moves back and forth along its axial direction without any offset or deviation, such that the purity of the high pitch produced by the tweeter can be ensured.

It is worth mentioning that there is no centering supporting element (spider) in the tweeter according to the present invention. Those who skilled in the art would easily understand that the resilient suspension member 22 and the inverted concave diaphragm 21 can also be applied in other kinds of speakers or sound effect devices including the conventional speakers with the spider. In other words, the vibrating structure 200 can also be applied in all kinds of speakers or sound effect devices including the conventional speakers with the spider.

According to the preferred embodiment of the present invention, the inverted concave diaphragm 21 has a concave curved shape, wherein parameters including an arc height H and a curvature R of the inverted concave diaphragm 21 are determined based on the size and shape of the tweeter. In particular, a suitable diameter of the tweeter is ranged from 8 mm to 38 mm in the present invention. Regarding the suitable diameter range of the tweeter, the arc height H is ranged from 5 mm to 7 mm and the curvature R is ranged from 15 mm to 20 mm. Preferably, the diameter of the tweeter in the present invention is preferably set from 10 mm to 20 mm. More preferably, regarding the tweeter with a preferable diameter range between 10-15, or 15-20 mm, the arc height H is preferably ranged from 5.5 mm to 6.5 mm and the curvature R is preferably ranged from 16 mm to 18 mm, for example 17 mm.

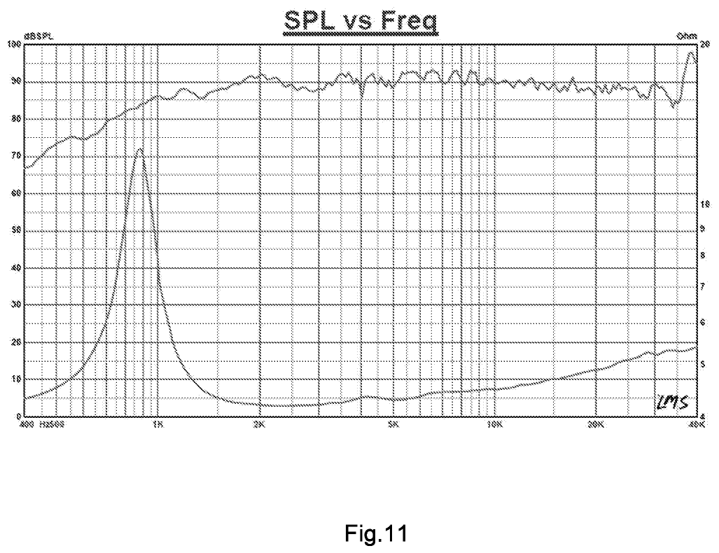

According to the configuration as described above in the preferred embodiment of the present invention, as shown in FIG. 11, the abscissa is the frequency (in units of HZ), and the ordinate is decibel (in units of dBSPL). According to the test result of the LMS electroacoustic test system provided by the Linearx System Company in the United States, the high frequency of the tweeter can be extended to an ultra high frequency of 40 kHz, that such outstanding performance in the high frequency band significantly enhances the high-pitch sound effect of the tweeter apparently.

According to the preferred embodiment of the present invention, the arc height H is selected between 5-7 mm and the curvature R is selected between 15-20 mm, such that the tweeter with the inverted concave diaphragm 21 is able to provide a high-pitch sound with a high frequency of 2560 Hz or even to provide a high-pitch sound with an ultra high frequency of 40 kHz or more, as shown in the test result in the FIG. 11, that is unexcepted to the current tweeter technology. As described in the background of this patent application, those skilled in the art believes that only when the diaphragm is protruded at a mid-portion thereof, the tweeter is able to produce a high-pitch sound with a high frequency ranging from 20 kHz to 2560 Hz. However, according to the present invention, the inverted concave diaphragm 21 is in a concave curved shape with the predetermined arc height H and curvature R as disclosed above, the tweeter of the present invention is enabled to produce a high-pitch sound with a high frequency of 2560 Hz or more, and even a high-pitch sound with an ultra-high frequency of 40 kHz or more, which substantially overcomes the technical bias of those who skilled in the art. In other words, the tweeter of the present invention has an unexpected sound effect compared with the conventional tweeters.

In addition, the concave shape of the inverted concave diaphragm 21 enables the inverted concave diaphragm 21 to converge and gather the high-pitch sound produced by the tweeter of the present invention. Compared with the conventional tweeter which has a vibrating diaphragm with convex protruding structure, the high-pitch sound produced by the tweeter of the present invention is able to be converged and gathered to ensure the high-pitch sound generated from the tweeter being more concentrated so as to broaden the application scenario of the tweeter of the present invention. For example, the tweeter as disclosed in the present invention can be applied in a head-mounted sound effect device, such as headphone.

More particularly, the inverted concave diaphragm 21 has a circular shaped lower concave arc portion 212 and a ring-shaped upper flat portion 211 surrounding around a peripheral edge of the lower concave arc portion 212, wherein the ring-shaped resilient suspension member 22 is integrally coupled to the upper flat portion 211 of the inverted concave diaphragm 21. In other words, the lower concave arc portion 212 is downwardly and curvedly extended from the upper flat portion 211 to form an arc shape. It is worth mentioning that the lower concave arc portion 212 is positioned within the voice coil 30. In other words, the voice coil 30 coaxially encircles at least a portion of the lower concave arc portion 212. In addition, the inverted concave diaphragm 21 is preferred to be made of metallic material, for example, but not limited to, aluminum. In other words, the inverted concave diaphragm 21 is embodied as metallic diaphragm, such as aluminum diaphragm, to enhance the structural strength thereof so as to prevent the inverted concave diaphragm 21 being accidentally deformed when it is being driven to reciprocatingly move back and forth, so that the purity of the high-pitch voice can be ensured. When the resilient suspension member 22 is made by molding, the inverted concave diaphragm 21 is received in the formation mould to be integrally molded with the resilient suspension member 22 to form an one-piece structure. In other words, the inverted concave diaphragm 21 is integrally coupled with the resilient suspension member 22 that the arc height H of the inverted concave diaphragm 21 is the arc height of the lower concave arc portion 212, and the curvature R of the inverted concave diaphragm 21 is the curvature of the lower concave arc portion 212.

According to the preferred embodiment of the present invention, the resilient suspension member 22 is made of resilient or elastic material and arranged between the inverted concave diaphragm 21 and the connecting frame 13. For example, the resilient suspension member 22 can be, but not limited to, rubber made member. According to the preferred embodiment of the present invention, the resilient suspension member 22 is integrally coupled with the inverted concave diaphragm 21 and the connecting frame 13 in such a manner that the resilient suspension member 22 is arranged between the inverted concave diaphragm 21 and the connecting frame 13. More specifically, the resilient suspension member 22 comprises an inner suspension edge portion and an outer suspension edge portion integrally extended from the inner suspension edge portion to form an integral ring-shaped body which surrounds and encircles around the inverted concave diaphragm inverted concave diaphragm 21. Along the sectional direction, the inner suspension edge portion and the outer suspension edge portion are integrally formed together to have a plane, pleated, arched, or wavy shaped cross section. According to the preferred embodiment of the present invention, the inner suspension edge portion and the outer suspension edge portion are integrally formed together to have a planar structure.

It is worth mentioning that the resilient suspension member 22 and the inverted concave diaphragm 21 can be made of different materials. For example, the resilient suspension member 22 can be made of a material softer than that of the inverted concave diaphragm 21. As such, through a combination of soft and hard materials of the resilient suspension member 22 and the inverted concave diaphragm 21 respectively, rapid transmission of the pulling stress can be substantially prevented, ensuring the inverted concave diaphragm 21 to vibrate more regularly.

The resilient suspension member 22 comprises a ring-shaped suspension member body 221 and a plurality of resilient ribs 222 intervally and spacedly integrally provided around the suspension member body 221 along a circumferential direction thereof, wherein each of the resilient ribs 222 is integrally protruded from the suspension member body 221 and the distances between every two of the resilient ribs 222 are preferred to be equal so as to ensure the resilient ribs 222 being arranged intervally and radially in an equal spacing manner so as to limit and restrict the displacement direction of the resilient suspension member 22 in an upward manner along its axial direction. In one alternative mode of the tweeter according to the preferred embodiment of the present invention, the resilient ribs 222 are intended along the suspension member body 221 integrally, intervally, spacedly, and radially, wherein the distances between every two of the resilient ribs 222 are arranged to be equal too. In another alternative mode of the tweeter according to the preferred embodiment of the present invention, some of the resilient ribs 222 are protruded on the suspension member body 221 to form protruding resilient ribs while some of the resilient ribs 222 are indented on the suspension member body 221 to form indenting resilient ribs. For example, each indenting resilient rib 222 is positioned between two adjacent protruding resilient ribs 222. Therefore, in particular, when resilient suspension member 22 is experienced either a forth or a back displacement having a tendency of offsetting from its axial direction, the resilient ribs 222 protruding in an opposing direction, either the protruding resilient ribs or the indenting resilient ribs correspondingly, will provide a restriction effect to prevent the resilient suspension member 22 from further offset displacement. In addition, the protruding shape of each of the protruding resilient ribs 222 provided on one side of the suspension member body 221 should not be limited to any specific shape, and that the indenting resilient ribs 222 provided on the other side of the suspension member body 221 can also be any shape. For example, the sectional shape of the resilient ribs can be bow shape, arc shape, triangular shape, quadrangular shape, polygonal shape, semi-circular shape, semi-elliptical shape, inverted U shape, inverted V shape, and etc.

It is worth mentioning that when the inner suspension edge portion and an outer suspension edge portion of the resilient suspension member 22 are made in folded shape, pleated shape, arc shape, or wave shape structure, the resilient ribs 222 of the resilient suspension member 22 can be arranged and aligned around the inner suspension edge portion or the outer suspension edge portion in a spiral manner according to the need, or that the resilient ribs 222 of the resilient suspension member 22 are arranged and aligned around both the inner suspension edge portion and the outer suspension edge portion in a spiral manner, wherein such arrangement should not be considered as limitation of the scope of the present invention. According to this preferred embodiment, the resilient ribs 222 are arranged in spiral manner to produce a centripetal force at the inverted concave diaphragm 21 towards a central axis of the tweeter, so as to restrict the vibration direction of the inverted concave diaphragm 21B along the axial direction of the tweeter.

It is worth mentioning that, the tweeter of the present invention does not contain any spider but there is no influence to its sound quality. In fact, by means of the restriction effect of the resilient ribs 222, the inverted concave diaphragm 21 of the tweeter is limited to produce forth and back displacement along its axial direction, so as to prevent the inverted concave diaphragm 21 from generating noise while producing sound from agitating air. In addition, since there is no spider in the tweeter of the present invention, the distance between the voice coil 30 and the inner surface of the speaker casing 10 can be decreased to obtain a more compact structure in size. Since the distance between the voice coil 30 and the speaker casing 10 can be decreased, the possible movement and displacement space for the voice coil 30 to be deviated or diverged from the axial direction of the tweeter is reduced correspondingly, and thus preventing the sound coil 30 from shaking while the voice coil 30 being deviated or diverged from the axial direction of the tweeter for a relatively bigger amplitude. In addition, the elimination of the spider n the tweeter substantially reduces the manufacturing cost and complication of the tweeter while enabling the tweeter to be manufactured in more compact size.

According to the preferred embodiment of the present invention, the magnet unit 40 comprises a magnet protective enclosure 41, a permanent magnet 42 and at least one magnetizer 43, wherein the permanent magnet 42 is positioned below the magnetizer 43 and disposed within the magnet protective enclosure 41. A magnetic gap 44 is formed between the permanent magnet 42 and the magnet protective enclosure 41. In other words, the permanent magnet 42 and the magnetizer 43 are disposed in the magnet protective enclosure 41 at a position that the permanent magnet 42 is located below the permanent magnet 42 and a magnetic gap 44 is formed between the permanent magnet 42 and the magnet protective enclosure 41. One end portion of the voice coil 30 is coupled to the inverted concave diaphragm 21 of the vibrating unit 20, while the opposing end portion of the voice coil 30 is positioned in the magnetic gap 44 to couple with the magnet unit 40. The magnet protective enclosure 41 may have a conventional U-iron structure, while the magnetizer 43 may have a conventional polar structure. The configuration of the magnet protective enclosure 41 and the magnetizer 43 is adapted to ensure the magnetic field in the magnetic gap 44, that is to guide the magnetic field lines of force of the permanent magnet 42 to the magnetic gap 44, such that the magnet unit 40 is capable of interacting with the voice coil 30 positioned in the magnetic gap 44. In other words, the magnet protective enclosure 41, the permanent magnet 42 and the magnetizer 43 are incorporated with each other to define a magnetic field loop to interact with the voice coil 30 to generate vibration. In other words, one end portion of the voice coil 30 is coupled with the inverted concave diaphragm 21 and the other end portion of the voice coil 30 is extended to the magnetic gap 44, so that the voice coil 30 is able to be reacted with magnet unit 40 magnetically so as to drive the voice coil 30 to move forth and back reciprocatingly by the magnet unit 40.

According to the preferred embodiment of the present invention, the permanent magnet 42 may be embodied as magnetic stone, magnetic iron or magnetic steel, such as metal magnets, ferrite magnets, rare earth magnets, and etc. In this preferred embodiment of the present invention, the permanent magnet 42 can be embodied as a neodymium iron boron magnet to provide magnetic power in the magnet unit 40 to form the magnetic field loop passing through the magnetic gap 44.

It is understandable that the components of the magnet unit 40 can be assembled by adhesive to form an integral body, or that, the magnet unit 40 may also made by means of injection molding. In particular, the magnetic protective enclosure 41, the permanent magnet 42 and the magnetizer 43 can be assembled to form the integral body by means of injection molding.

According to the preferred embodiment of the present invention, the magnet unit 40 comprises a magnetic loop connecting member 48 which is arranged between the magnetic protective enclosure 41 and the casing panel 11. In other words, the magnet unit 40 is connected with the casing panel 11 of the speaking casing 10 by means of the magnetic loop connecting member 48, so as to couple the inverted concave diaphragm 21 of the vibration unit 20 and the resilient suspension member 22 with the magnet unit 40 to form an integral structure. In particular, the magnetic loop connecting member 48 comprises a connecting body 481 and a plurality of positioning slots 483, wherein the connecting body 481 is a ring-shaped body that the positioning slots 483 are spacedly provided around the connecting body 481. The casing panel 11 comprises a plurality of positioning latches 111 provided thereon in correspondence with the number and size of the positioning slots 483 adapted for fittingly and securely inserting into the positioning slots 483 respectively to secure and assemble the magnetic loop connecting member 48 with the casing panel 11. It is appreciated that the plurality of positioning latches 111 may also be embodied to be provided on the magnetic loop connecting member 48 while the plurality positioning slots 483 is provided on the casing panel 11 correspondingly, or that both the casing panel 11 and the magnetic loop connecting member 48 are provided with both the positioning latches 111 and the positioning slots 483 correspondingly.

According to the preferred embodiment of the present invention, the casing panel 11 has at least one engaging groove 112 and the resilient suspension member 22 further comprises a connecting edge 223 which is a ring-shaped outer edge integrally and outwardly extended from the suspension member body 221, wherein the engaging groove 112 is a circular groove formed in an outer surface of the casing panel 11 and adapted to receive at least a portion of the ring-shaped connecting edge 223 therein, so as to connect the resilient suspension member 22 with the casing panel 11. The resilient suspension member 22 may be made of an elastic or resilient material by injection molding, wherein the connecting edge 223 is integrally formed while the resilient material forming suspension member body 221 and the resilient ribs 222 during the injection molding, wherein the connecting edge 223 is coupled with the outer surface of the casing panel 11 so as to connect the resilient suspension member 22 with the casing panel 11. According to this preferred embodiment of the present invention, during the injection molding process, the liquid form resilient material flows into the engaging groove 112 of the casing panel 11 to form the ring-shaped connecting edge 223. It is worth mentioning that the casing panel 11 may further has a plurality of engaging through holes 113 evenly and intervally provided in the casing panel 11, wherein the engaging through holes 113 are spacedly positioning around engaging groove 112 of the casing panel 11 so that during the molding formation of the resilient suspension member 22, the liquid form resilient material also flows into the engaging through holes 113 to provide an enhanced engagement strength for the connection of resilient suspension member 22 and the casing panel 11.

According to this preferred embodiment of the present invention, the tweeter further comprises a damping unit 50 provided on the back cover 12 of the speaker casing 10, wherein when the tweeter is assembled or disposed at a flat surface, the damping unit is adapted for supporting the tweeter at the flat surface and absorbing shocks. In particular, the damping unit 50 is made of resilient or elastic material such that while supporting the tweeter, the dimpling unit 50 is able to release the vibration generated by the tweeter during operation by transmitting to the dimpling unit 50, thereby achieving a cushioning and shock reducing effect.

According to this preferred embodiment of the present invention, the tweeter further comprises a protective cover 60 positioned on the casing panel 11 of the speaker casing 10 for protecting the inverted concave diaphragm 21 of the vibration unit and the resilient suspension member 22. It is appreciated that the protective cover 60 has a plurality of opening holes therein to facilitate the transmission of sound while enhancing the aesthetic effect.

According to another aspect of the present invention, it further provides a manufacturing method of the tweeter according to the first preferred embodiment of the present invention, wherein the method comprises the following steps.

(a) Dispose the inverted concave diaphragm 21 of the vibrating unit 20 and the back cover 12 of the speaker casing 10 within a formation mould, such as an injection formation mould.

(b) Form the resilient suspension member 22 coupling with the inverted concave diaphragm 21 and the casing panel 11 in the formation mould by injection molding.

(c) Install the voice coil 30 between the magnet unit 40 and the vibrating unit 20.

(d) Couple the vibrating unit 20 with the magnet unit 40 by the magnetic loop connecting member 48.

(e) Couple the back cover 12 with the casing panel 11 of the speaker casing 10.

In the step (a), the inverted concave diaphragm 21 is a metal diaphragm, such as aluminum diaphragm.

In the step (a), the inverted concave diaphragm 21 has a concave arc shape, wherein an arc height H and a curvature R thereof are determined in accordance with the size and shape of the tweeter. In particular, when the diameter of the tweeter is selected from 8 mm to 38 mm, the arc height H is ranged from 5 mm to 7 mm and the curvature R is ranged from 15 mm to 20 mm.

In the step (c), one end of the voice coil 30 is connected with the inverted concave diaphragm 21 of the vibration unit 20 and the other end of the voice coil 30 is extended in the magnetic gap 44 defined between the magnet unit 40, wherein the magnetic gap 44 is the space formed between the permanent magnet 42 and the magnetic protective enclosure 41.

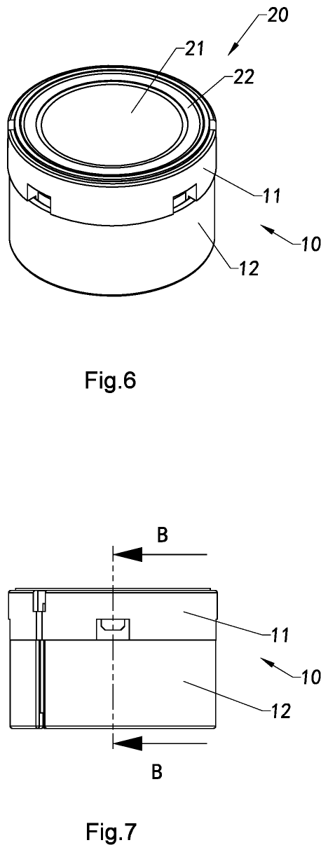

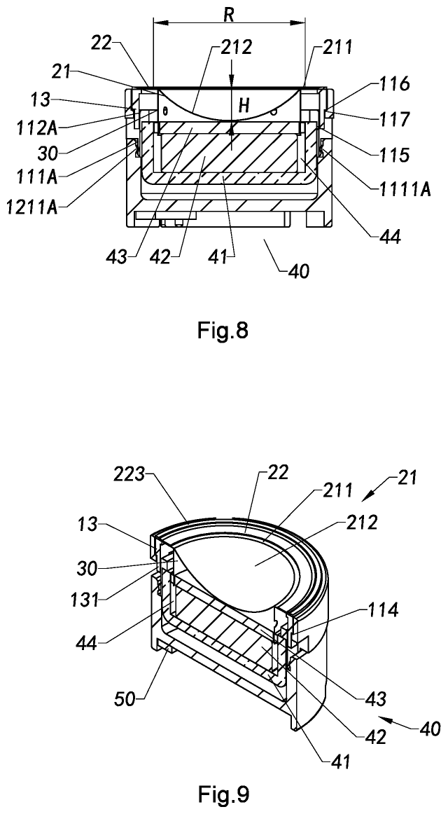

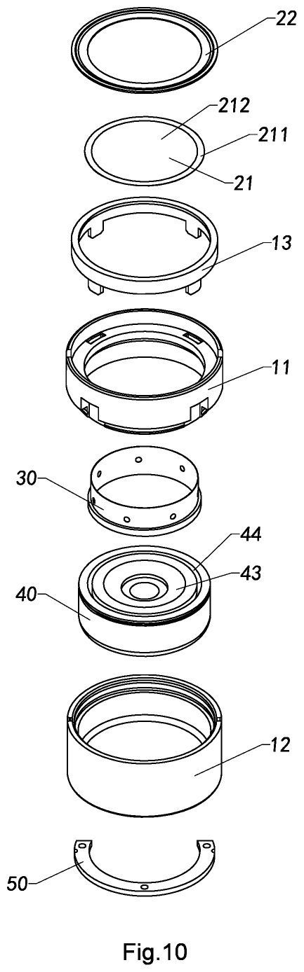

Referring to FIGS. 6 to 10, a tweeter according to a second preferred embodiment of the present invention is illustrated, wherein the quality of the tweeter is enhanced by its innovative vibrating diaphragm structure and its manufacturing process that not only reduces the manufacturing cost thereof, but also reduces the manufacturing steps thereof while enhancing the manufacturing quality. The tweeter comprises a speaker casing 10, a vibration unit 20, a voice coil 30, and a magnet unit 40, wherein the vibration unit 20, the voice coil 30 and the magnet unit 40 are arranged in the speaker casing 10. One end of the voice coil 30 is coupled with the vibration unit 20 and the other end of the voice coil 30 is arranged to coupling and equipping with the magnet unit 40. In other words, the voice coil 30 is positioned between the vibration unit 20 and the magnet unit 40, and the speaker casing 10 receives the vibration unit 20, the voice coil 30 and the magnet unit 40 therein. It is worth mentioning that the voice coil 30 is driven to move forth and back reciprocatingly by the electromagnetic force of the magnet unit 40 so as to drive the vibration unit 20 to move forth and back reciprocatingly along an axial direction of the tweeter correspondingly to agitate air inside and around the tweeter to produce sound.

According to the second preferred embodiment of the present invention, the speaker casing 10 comprises a casing panel 11 and a back cover 12 sealedly coupled with the casing panel 11 to receive the vibrating unit 20, the voice coil 30 and the magnet unit 40 therein. It is appreciated that the casing panel 11 and the back cover 12 can be coupled with each other by various means, including, but not limited to, by means of latch and lock assembly, threaded connecting structure, hot welding, ultrasonic bonding, and etc.

According to the preferred embodiment of the present invention, the vibrating unit 20 comprises an inverted concave diaphragm 21 and a resilient suspension member 22 integrally coupled with the inverted concave diaphragm 21. Furthermore, the resilient suspension member 22 is made by injection molding and to integrally connect with the inverted concave diaphragm 21 during the injection molding process. It is worth mentioning that the speaker casing further comprises a connecting frame 13, wherein the resilient suspension member 22 is integrally connected to the connecting frame 13 during the formation of the resilient suspension member 22 by injection molding. In other words, by means of the injection molding process, the resilient suspension member 22, the inverted concave diaphragm 21 and the connecting frame 13 are integrally formed and become an integral component of the tweeter, i.e. an integrated vibrating structure 200 of the tweeter. It is appreciated that the resilient suspension member 22 is made by the technology of embedded injection molding, wherein the connecting frame 13 and the inverted concave diaphragm 21 are disposed in the formation mould, and then a resilient molding material for forming the resilient suspension member 22 is heated to liquid form and fills into the formation mould to attach on corresponding portions of the connecting frame 13 and the inverted concave diaphragm 21, so that the resilient suspension member 22 is formed after the resilient molding material is solidified after cooling down while securely affixing the connecting frame 13 and the inverted concave diaphragm 21 to form the integral component.

In addition, since one end of the voice coil 30 is coupled with the vibration unit 20 while the other end of the voice coil 30 is arranged to coupling and equipping with the magnet unit 40, so that the voice coil 30 is driven to move forth and back reciprocatingly by the electromagnetic force of the magnet unit 40 so as to drive the vibration unit 20 to move forth and back reciprocatingly along an axial direction of the tweeter. It is appreciated that the movement the inverted concave diaphragm 21 is limited to the axial direction of the tweeter by the the resilient suspension member 22. Correspondingly, the inverted concave diaphragm 21 is restricted to only move along the axial direction of the tweeter without offsetting, deviating or diverging that substantially enhances the sound quality of the tweeter.

It is worth mentioning that, the tweeter of the present invention does not contain any conventional spider. Person skilled in this art should understand that the inverted concave diaphragm 21 and the resilient suspension member 22 of the present invention may also apply in other speakers and acoustic devices, including those containing spiders.

In this preferred embodiment of the present invention, the inverted concave diaphragm 21 is in a concave curved shape with parameters of arc height H and curvature R predetermined with respect to the size of the tweeter, such as when a diameter of the tweeter is ranged between 8-38 mm, the arc height H is ranged between 5-7 mm and the curvature R is ranged between 15-20 mm. Furthermore, the inverted concave diaphragm 21 has a ring-shaped upper flat portion 211 and a circular shaped lower concave arc portion 212, wherein the ring-shaped upper flat portion 211 is circularly surrounding around the lower concave arc portion 212, wherein the ring-shaped resilient suspension member 22 is integrally coupled to the upper flat portion 211 of the inverted concave diaphragm 21. In addition, the lower concave arc portion 212 is downwardly and curvedly extended from the upper flat portion 211 to form an arc shape. It is worth mentioning that the lower concave arc portion 212 is positioned within the voice coil 30. In other words, the voice coil 30 coaxially encircles at least a portion of the lower concave arc portion 212. It is worth mentioning that the inverted concave diaphragm 21 is preferred to be made of metallic material, for example, but not limited to, aluminum. In other words, the inverted concave diaphragm 21 is embodied as metallic diaphragm, such as aluminum diaphragm, and made to couple with the resilient suspension member 22 during the formation of the resilient suspension member 22.

According to the preferred embodiment of the present invention, the resilient suspension member 22 is made of resilient or elastic material and arranged between the inverted concave diaphragm 21 and the connecting frame 13. Preferably, the resilient suspension member 22 is integrally coupled with the inverted concave diaphragm 21 and the connecting frame 13. More specifically, the resilient suspension member 22 comprises an inner suspension edge portion and an outer suspension edge portion integrally extended from the inner suspension edge portion to form an integral ring-shaped body which surrounds and encircles around the inverted concave diaphragm inverted concave diaphragm 21. The inner suspension edge portion and the outer suspension edge portion are integrally formed together to have a plane, pleated, arched, or wavy shaped structure. According to the preferred embodiment of the present invention, the inner suspension edge portion and the outer suspension edge portion are integrally formed together to have a planar structure. It is worth mentioning that the resilient suspension member 22 is able to be made of the same softer material as the inverted concave diaphragm 21, such that the similar material used to make the resilient suspension member 22 and the inverted concave diaphragm 21 is capable of preventing rapid transmission of the pulling stress thereof so as to ensure the inverted concave diaphragm 21 having more regular vibration.

According to the preferred embodiment of the present invention, the magnet unit 40 comprises a magnet protective enclosure 41, a permanent magnet 42 and at least one magnetizer 43, wherein the permanent magnet 42 is positioned below the magnetizer 43 and disposed within the magnet protective enclosure 41. A magnetic gap 44 is formed between the permanent magnet 42 and the magnet protective enclosure 41. In other words, the permanent magnet 42 and the magnetizer 43 are disposed in the magnet protective enclosure 41 at a position that the permanent magnet 42 is located below the permanent magnet 42 and a magnetic gap 44 is formed between the permanent magnet 42 and the magnet protective enclosure 41. One end of the voice coil 30 is coupled to the inverted concave diaphragm 21 of the vibrating unit 20, while the opposing end of the voice coil 30 is positioned in the magnetic gap 44 to couple and equipped with the magnet unit 40. In other words, The configuration of the magnet protective enclosure 41 and the magnetizer 43 is adapted to form a magnetic field loop to associate and equip with the voice coil 30 for generating vibration.

According to the preferred embodiment of the present invention, the permanent magnet 42 may be embodied as magnetic stone, magnetic iron or magnetic steel, such as metal magnets, ferrite magnets, rare earth magnets, and etc. In this preferred embodiment of the present invention, the permanent magnet 42 can be embodied as a neodymium iron boron magnet to provide magnetic power in the magnet unit 40 to form the magnetic field loop passing through the magnetic gap 44.

According to the second preferred embodiment of the present invention, the casing panel 11 comprises at least a positioning latch 111A, a casing panel body 116 and at least a protrusion edging element 115 and has at least an engaging groove 112A and one or more positioning grooves 117. The one positioning latch 111A is downwardly extended from the casing panel body 116 and has an engaging slot 1111A provided therein. The back cove 12 has at least a ring-shaped engaging slot 121A forming an engaging hook 1211A, such that when the casing panel 11 and the back cover 12 are assembled together, the positioning latch 111A is inserted into the ring-shaped engaging slot 121A and the engaging hook 1211A is engaged with the engaging slot 1111A. It is understood that the engaging slot 1111A may be provided at the ring-shaped engaging slot 121A and the engaging hook 1211A may be provided at the ring-shaped positioning latch 111A so as to couple the casing panel 11 with the back cover 12 during assembling. Accordingly, it is understood that the ring-shaped positioning latch 111A may be provided at the back cover 12 and the ring-shaped engaging slot 121A may be provided at the casing panel 11. The connecting frame 13 comprises a plurality of connecting and positioning latches 131 adapted to be inserted into the one or more positioning grooves 117, such that when the connecting frame 13 is positioned at the engaging groove 112A, the connecting and positioning latches 131 are inserted into the one or more positioning grooves 117 respectively. The casing panel body 116 is in ring shape, and the protrusion edging element 115 is extended to protrude out of an annular inner side of the casing panel body 116. According to this preferred embodiment of the present invention, the resilient suspension member 22 further comprises a connection edge 223 which securely connects the resilient suspension member 22 to the connecting frame 13. The resilient suspension member 22 is able to be made by injection molding with resilient material while the connection edge 223 is integrally form at the same time by injection molding and disposed on an outer surface of the connecting frame 13, so as to connect the resilient suspension member 22 with the connecting frame 13 with each other.

According to this preferred embodiment of the present invention, the tweeter further comprises a damping unit 50 provided on the back cover 12 of the speaker casing 10, wherein when the tweeter is assembled or disposed at a surface, the damping unit is adapted for supporting the tweeter at the flat surface and absorbing shocks. In particular, the damping unit 50 is made of resilient or elastic material such that while supporting the tweeter, the dimpling unit 50 is able to release the vibration generated by the tweeter during operation by transmitting to the dimpling unit 50, thereby achieving a cushioning and shock reducing effect.

It is appreciated that a manufacturing method of the tweeter according to the second preferred embodiment of the present invention is provided, wherein the method comprises the following steps.

(A) Dispose the inverted concave diaphragm 21 of the vibrating unit 20 and the back cover 12 of the speaker casing 10 within a formation mould such as injection formation mould.

(B) Form the resilient suspension member 22 coupling with the inverted concave diaphragm 21 and the connecting frame 13 by injection molding.

(C) Install the voice coil 30 between the magnet unit 40 and the vibrating unit 20.

(D) Couple the vibrating unit 20 with the magnet unit 40 by the casing panel 11 of the speaker casing 10.

(E) Couple the speaker casing 10 with the back cover 12.

In the step (A), the inverted concave diaphragm 21 has a concave arc shape, wherein an arc height H and a curvature R thereof are determined in accordance with the size and shape of the tweeter. In particular, when the diameter of the tweeter is selected from 8 mm to 38 mm, the arc height H is ranged from 5 mm to 7 mm and the curvature R is ranged from 15 mm to 20 mm.

In the step (D), the casing panel 11 is coupled with the connecting frame 13, and the inverted concave diaphragm 21 and the resilient suspension member 22 of the vibrating unit 20 are assembled to the casing panel 11.

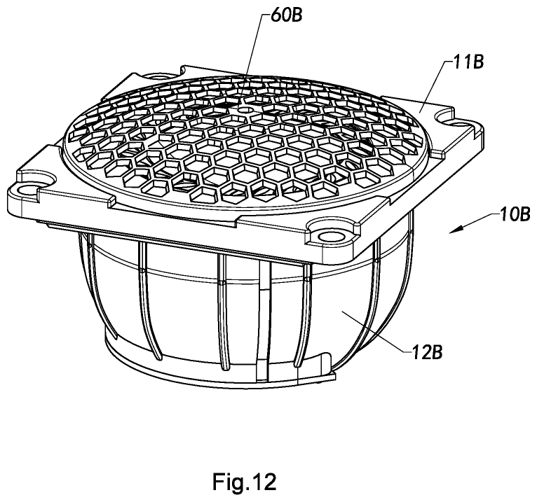

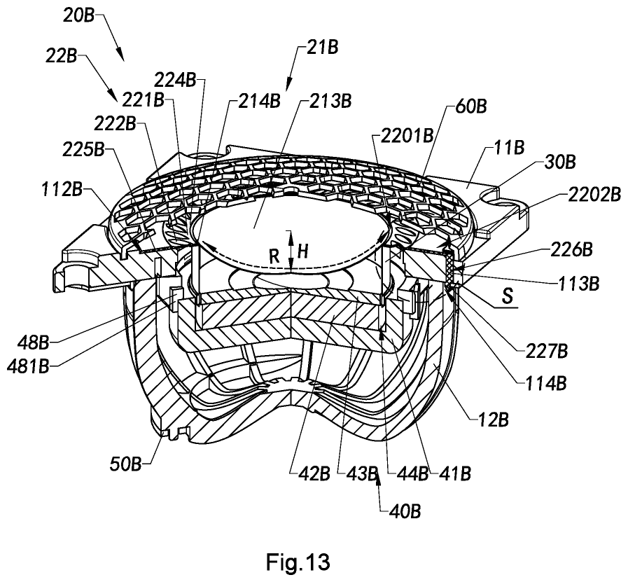

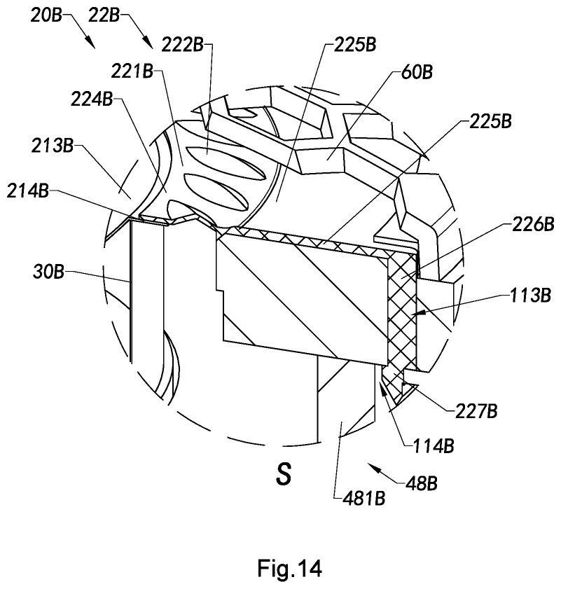

Referring to FIGS. 12 to 14 of the drawings, a tweeter according to a third preferred embodiment of the present invention is illustrated, wherein the tweeter comprises a speaker casing 10B, a vibrating unit 20B, a voice coil 30B, and a magnet unit 40B, wherein the speaker casing 10B comprises a casing panel 11B and a back cover 12B coupled with the casing panel 11B, wherein the vibrating unit 20B and the magnet unit 40B are installed to the casing panel 11B of the speaker casing 10B, wherein the magnet unit 40B is retained in a cavity formed between the casing panel 11B and the back cover 12B. One end portion of the voice coil 30B is coupled with the vibrating unit 20B while the opposing end portion of the voice coil 30B is arranged to be coupled and equipped with the magnet unit 40B. When the magnet unit 40B is electrically powered on, the voice coil 30B, being driven by the electromagnetic driving force produced by the magnet unit 40B, is actuated to reciprocatingly vibrate back and force, thereby driving the vibrating unit 20B to reciprocatingly vibrate back and force to produce sound by agitating the air therearound.

Preferably, the voice coil 30B, being driven by the electromagnetic driving force generated by the voice coil 30B, is able to drive the vibrating unit 20B to vibrate back and force along an axial direction of the tweeter without offsetting and deviating, such that the sound effect of the tweeter can be guaranteed.

More specifically, the vibrating unit 20B comprises an inverted concave diaphragm 21B and a resilient suspension member 22B, wherein the resilient suspension member 22B comprises an inner side 2201B integrally coupled to the inverted concave diaphragm 21B and an outer side 2202B integrally coupled to the casing panel 11B of the speaker casing 10B. In other words, the resilient suspension member 22B is extended inwardly to integrally couple to the inverted concave diaphragm 21B and outwardly to integrally couple to the casing panel 11B of the speaker casing 10B, such that no adhesion is required for the connection between the inner side 2201B of the resilient suspension member 22B and the inverted concave diaphragm 21B, and between the outer side 2202B of the resilient suspension member 22B and the casing panel 11B of the speaker casing 10B. Therefore, the manufacturing process of the tweeter can be reduced while preventing the resilient suspension member 22B detaching from the inverted concave diaphragm 21B and the casing panel 11B of the speaker casing 10B. Moreover, the resilient suspension member 22B and the inverted concave diaphragm 21B have good consistency at the bonding positions therebetween, wherein when the vibrating unit 20B is vibrating back and forth, the inverted concave diaphragm 21B is substantially limited by the resilient suspension member 22B to merely vibrate along the axial direction of the tweeter, so that the purity of the tweeter can be ensured while enhancing the high-pitch sound effect thereof.

Those who skilled in the art would understand that since adhesive glue is used to bond the vibrating diaphragm with the suspension member and bond the suspension member with the casing panel conventionally, the good fluidity of the adhesive glue will lead to worse bonding consistency in the bonding position between the vibrating diaphragm and the suspension member as well as the bonding position between the suspension member and the casing panel. On the contrary, the inner side 2201B of the resilient suspension member 22B is integrally coupled to the inverted concave diaphragm 21B and the inner side 2201B of the resilient suspension member 22B is integrally coupled to the casing panel 11B of the speaker casing 10B by means of injection molding during the molding formation of the resilient suspension member 22B, so that the consistency at the bonding position between the inner side 2201B of the resilient suspension member 22B and the inverted concave diaphragm 21B and at the bonding position between the outer side 2202B of the resilient suspension member 22B and the casing panel 11B of the speaker casing 10B can be secured, which is critical to ensure the reliability and the sound quality of the tweeter.

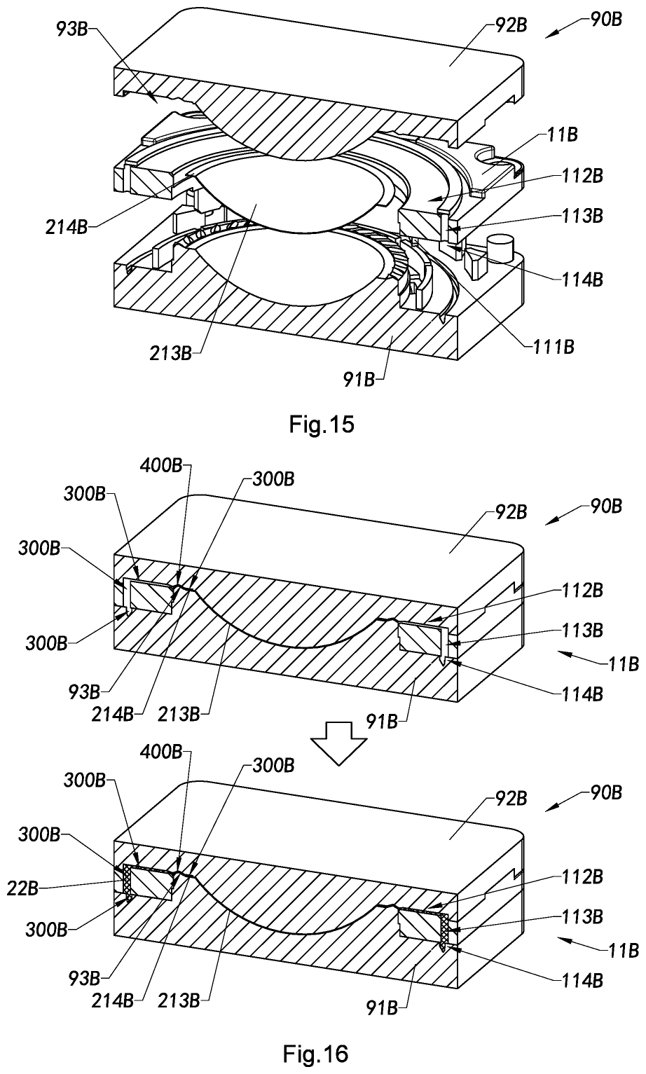

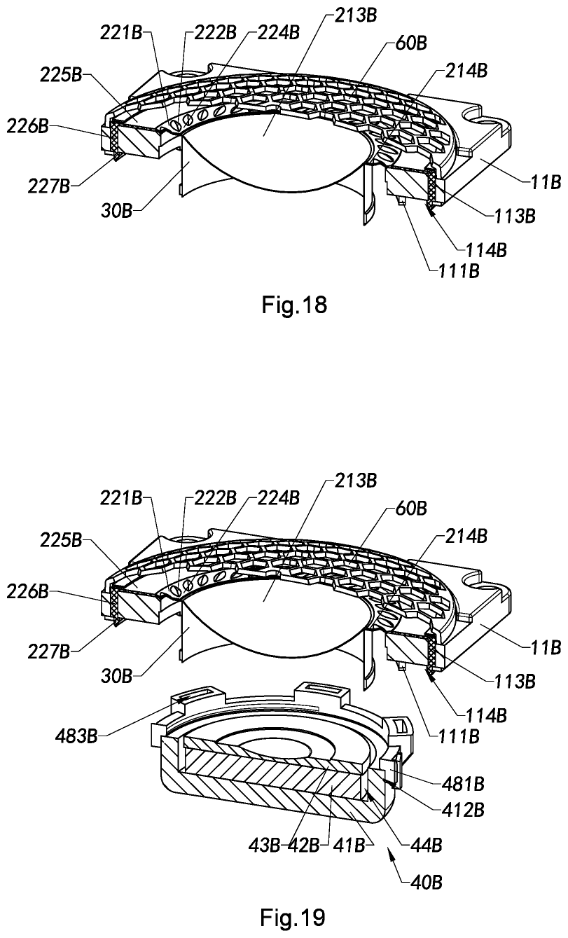

Accordingly, the casing panel 11B and the inverted concave diaphragm 21B are integrally coupled with the inverted concave diaphragm 21B at the inner side 2201B and the outer side 2202B thereof respectively, so as to form a vibrating structure 200B of the tweeter. In other words, the tweeter of the present invention has an integrated vibrating structure 200B. Referring to the FIGS. 15 to 17 of the drawings, a manufacturing process of the vibrating structure 200B is illustrated. FIGS. 18 to 20 further illustrate the manufacturing process of the tweeter.

In particular, as shown in the FIGS. 15 and 16 of the drawings, the inverted concave diaphragm 21B and the casing panel 11B having a ring shape are provided and then disposed in a lower mould 91B of a formation mould 90B at a position that the inverted concave diaphragm 21B is positioned at a mid-portion surrounded by the casing panel 11B. Then, the lower mould 91B is clamped and closed with an upper mould 92B to form a molding cavity 93B at an upper and/or lower portion of the casing panel 11B, at an upper and/or lower portion of the inverted concave diaphragm 21B, and between the casing panel 11B and the inverted concave diaphragm 21B, to form at least one gap 300B, communicating with the molding cavity 93B, between the inverted concave diaphragm 21B and the upper mould 92B and/or the lower mould 91B, and to form a space 400B between the casing panel 11B and the inverted concave diaphragm 21B. It is appreciated that the space 400B is formed between an inner wall of the casing panel 11B and an outer wall of the inverted concave diaphragm 21B. Generally, both the inner wall of the casing panel 11B and the outer wall of the inverted concave diaphragm 21B have a circular shape. After the inverted concave diaphragm 21B is disposed at the mid-portion encircling by the casing panel 11B, the space 400B in annular shape is formed between the inner wall of the casing panel 11B and the outer wall of the inverted concave diaphragm 21B, and a consistent distance is maintained between the inner wall of the casing panel 11B and the outer wall of the inverted concave diaphragm 21B. Preferably, the casing panel 11B and the inverted concave diaphragm 21B are disposed coaxially that shares the same center point, i.e. the center point of the casing panel 11B is the same and the center point of the inverted concave diaphragm 21B are the same. It is worth mentioning that since the casing panel 11B is in ring shape, the central axis of the tweeter passes through the common center point of the casing panel 11B and the center point of the inverted concave diaphragm 21B.

In the stage as shown in the FIG. 16 of the drawings, liquid form molding material 100B is injected into the molding cavity 93B until the molding cavity 93B is completely filled with the molding material 100B, wherein the molding material 100B covers the upper portion and/or lower portion of the casing panel 11B and the upper portion and/or lower portion of the inverted concave diaphragm 21B, and is retained in the space between the casing panel 11B and the inverted concave diaphragm 21B. In other words, the molding material 100B is guided to fill into every gap 300B and space 400B in the formation mould 90B. That is, the molding material 100B is guided to fill in the at least one gap 300B between the casing panel 11B and the upper mould 92B to cover the outer surface of the casing panel 11B, to fill in the at least one gap 300B between the inverted concave diaphragm 21B and upper mould 92B to cover the outer surface of the inverted concave diaphragm 21B, and to fill in the space 400B between the casing panel 11B and the inverted concave diaphragm 21B. It is worth mentioning that the type of the molding material 100B is not intended to be limiting in the present invention, as long as it can be solidified to form the deformable resilient suspension member 22B. For example, the molding material 100B may be embodied as rubber material that can be heated to liquid form. It is also worth mentioning that the curing mode of the molding material 100BB is not limited in the tweeter of the present invention, i.e. the molding material 100BB may be solidified and cured by heating or cooling.

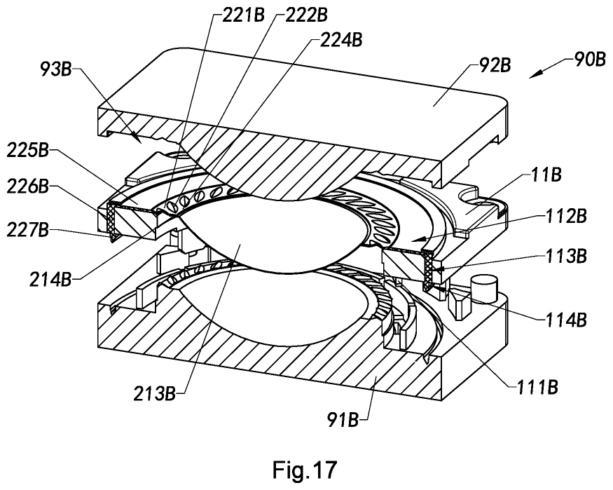

In the stage as shown in the FIG. 17, the molding material 100B is cured and solidified in the molding cavity 93B to obtain the vibrating structure 200B having a one-piece integral structure after the lower mould 91B and the upper mould 92B of the molding mould 90B are separated with each other. It is worth mentioning that the structure that the inner side 2201B of the resilient suspension member 22B encapsulates the upper surface of the inverted concave diaphragm 21B, while the outer side 2202B of the resilient suspension member 22B encapsulates the upper surface of the casing panel 11B, is merely exemplary in the preferred embodiment of the present invention, which is not intended to limit the scope of the present invention.

Accordingly, the resilient suspension member 22B comprises a suspension member body 221B, an inner side connecting edge 224B integrally and encirclingly provided at an inner side of the suspension member body 221B, and an outer side connecting edge 225B integrally and surroundingly provided at an outer side of the suspension member body 221B, wherein the inner side connecting edge 224B of the resilient suspension member 22B is integrally coupled to the inverted concave diaphragm 21B and the outer side connecting edge 225B of the 2B is integrally coupled to the casing panel 11B. In particular, the outer side connecting edge 225B of the resilient suspension member 22B defines an outer side 2202B of the resilient suspension member 22B.

It is worth mentioning that, in comparison with the conventional structure that the inner side connecting edge of the resilient suspension member is glued to the inverted concave diaphragm be means of adhesion as well as the outer side connecting edge of the resilient suspension member is glued to the casing panel, the resilient suspension member 22B has no need to be prefabricated or premade that substantially simplifies the manufacturing process of the tweeter and reduces the manufacturing cost of the tweeter. More important that, during the formation process of the resilient suspension member 22B, the inner side connecting edge 224B of the resilient suspension member 22B is integrally coupled with the inverted concave diaphragm 21B and the outer side connecting edge 225B of the resilient suspension member 22B is integrally coupled with the casing panel 11B, so that the resilient suspension member 22B is retained between the inverted concave diaphragm 21B and the casing panel 11B, that significantly ensures the resilient suspension member 22B, the inverted concave diaphragm 21B and the casing panel 11B of the vibration structure 200B are arranged in preferred positions and constructed with each other more precisely and securely, wherein the bonding position between the inner side connecting edge 224B of the resilient suspension member 22B and the inverted concave diaphragm 21B and the bonding position between the outer side connecting edge 225B of the resilient suspension member 22B and the casing panel 11B can be retained consistently. Therefore, when the inverted concave diaphragm 21B is being driven by the voice coil 30B to vibrate back and forth reciprocatingly, the resilient suspension member 22B is capable of limiting the inverted concave diaphragm 21B to vibrate reciprocating strictly along the axial direction of the tweeter without offsetting and deviating, so as to ensure the high-pitch sound effect of the tweeter.

In addition, during the molding process of the resilient suspension member 22B in the formation mould 90B, the inner side connecting edge 224B of the resilient suspension member 22B is integrally coupled with the inverted concave diaphragm 21B while the outer side connecting edge 225B of the resilient suspension member 22B is integrally coupled with the casing panel 11B, so that the inner side connecting edge 224B is able to be securely and reliably bonded to the inverted concave diaphragm 21B and the outer side connecting edge 225B is able to be securely and reliably bonded to the casing panel 11B. Therefore, when the inverted concave diaphragm 21B is being driven by the voice coil 30B to vibrate back and forth reciprocatingly, the integral connection of the inverted concave diaphragm 21B, the resilient suspension member 22B and the casing panel 11B can better prevent the inner side connecting edge 224B of the resilient suspension member 22B from detaching from or separating with the inverted concave diaphragm 21B and/or the outer side connecting edge 225B of the resilient suspension member 22B from detaching from or separating with the casing panel 11B, such that the reliability of the tweeter when it is in use is ensured.

Preferably, the casing panel 11B has at least one engaging groove 112B, in the stage as shown in FIG. 15, wherein the at least one engaging groove 112B of the casing panel 11B is facing toward the upper mould 92B of the formation mould 90B and communicating with molding cavity 93B. In the stage as shown in FIG. 16 of the drawings, the molding material 100B injected into the molding cavity 93B will flow and fill into the engaging groove 112B of the casing panel 11B, such that after the molding material 100B is cured and solidified, at least a portion of the outer side connecting edge 225B of the resilient suspension member 22B is received and formed in the engaging groove 112B of the casing panel 11B. Accordingly, the outer side connecting edge 225B of the resilient suspension member 22B can be more securely coupled to the casing panel 11B. Preferably, the whole outer side connecting edge 225B of the resilient suspension member 22B is preferred to be received in the engaging groove 112B of the casing panel 11B, so that the height of the tweeter can be reduced to facilitate the miniaturization of the tweeter.

In some embodiments of the tweeter of the present invention, the engaging groove 112B of the casing panel 11B has a ring shape, that is the engaging groove 112B is an annular groove. In other embodiments of the present invention, at least a portion of an upper surface of the casing panel 11B is intended to form the at least one engaging groove 112B, wherein if the casing panel 11B comprises two or more engaging grooves 112B spacedly, wherein two adjacent engaging grooves 112B are formed independently and separated with each other. It is important to mention that the shape and size of the engaging groove 112B is not intended to be limiting in the present invention, that is selectable according to the actual needs.

Preferably, the casing panel 11B has at least one engaging through hole 113B which penetrates from an upper surface to a lower surface of the casing panel 11B, according to the embodiment of the tweeter as shown in FIGS. 12 to 14, wherein the engaging through hole 113B is communicating with the engaging groove 112B. The resilient suspension member 22B further comprises a suspension member engaging portion 226B, which is downwardly and integrally extended from an outer peripheral edge of the outer side connecting edge 225B and retained in the engaging through hole 113B of the casing panel 11B, so as to reinforce the bonding strength between the resilient suspension member 22B and the casing panel 11B. For example, as shown in the FIG. 15 of the drawing, the engaging through hole 113B of the casing panel 11B is communicating with the molding cavity 93B, so that, in the stage as shown in the FIG. 16 of the drawings, the molding material 100B being filled into the molding cavity 93B flows and fills into the engaging through hole 113B of the casing panel 11B, such that after the molding material 100B is cured and solidified, the suspension member engaging portion 226B of the resilient suspension member 22B is retained in the engaging through hole 113B of the casing panel 11B.

It is worth mentioning that the engaging through hole 113B of the casing panel 11B is not intended to be limiting in its shape and size. For example, the engaging through hole 113B of the casing panel 11B may is a tubular hole according to some embodiments of the tweeter of the present invention. Alternatively, in other embodiments, the engaging through hole 113B is a conical hole that the inner diameter of a first portion of the engaging through hole 113B adjacent to the upper surface of the casing panel 11B is smaller than the inner diameter of a second portion of the engaging through hole 113B adjacent to the lower surface of the casing panel 11B. Of course, in other embodiments of the tweeter of the present invention, the engaging through hole 113B of the casing panel 11B may has a segmented structure, for example the engaging through hole 113B has two segments that the upper segment of the engaging through hole 113B is adjacent to the upper surface of the casing panel 11B, while the lower segment of the engaging through hole 113B is adjacent to the lower surface of the casing panel 11B, wherein the inner diameter of the upper segment is smaller than the inner diameter of the lower segment.

Further, the casing panel 11B has a retention slot 114B formed at the lower surface of the casing panel 11B, wherein after molding material 100B is filled into the molding cavity 93B of the formation mould 90B, the molding material 100B fills the retention slot 114B through the engaging through hole 113B of the casing panel 11B. After the molding material 100B is cured and solidified, a suspension retention portion 227B, integrally coupled to the suspension member engaging portion 226B, is formed in the retention slot 114B of the casing panel 11B, so as to prevent the outer side connecting edge 225B of the resilient suspension member 22B detaching from the casing panel 11B more effectively.

As mentioned above, since the suspension member is glued to the casing panel by means of adhesion, the suspension member is only attached to the outer surface of the casing panel and may easily get detached from the casing panel. According to the preferred embodiment of tweeter of the present invention, during the liquid form molding material 100B is molded to form the resilient suspension member 22B, the outer side connecting edge 225B of the resilient suspension member 22B is integrally coupled with the casing panel 11B that the outer side connecting edge 225B, the suspension member engaging portion 226B, and the suspension retention portion 227B are formed at the engaging groove 112B (formed at the upper surface of the casing panel 11B), at the engaging through hole 113B (through the casing panel 11B), and at the retention slot 114B (formed at the lower surface of the casing panel 11B) respectively, so that the resilient suspension member 22B is able to be securely coupled to the casing panel 11B. It is an unexpected result to the conventional art of tweeter.

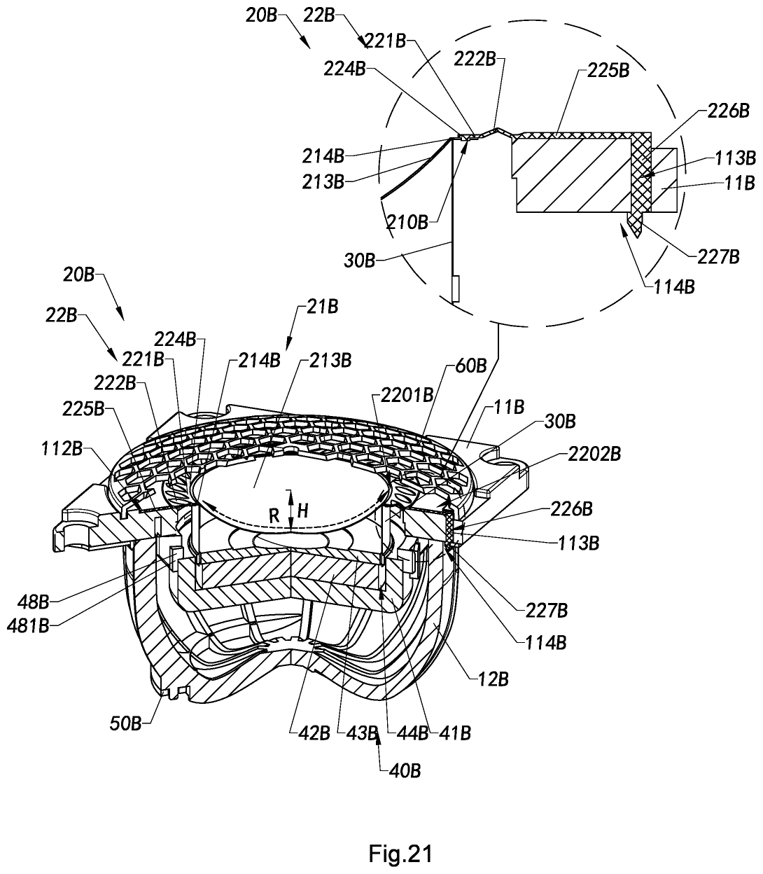

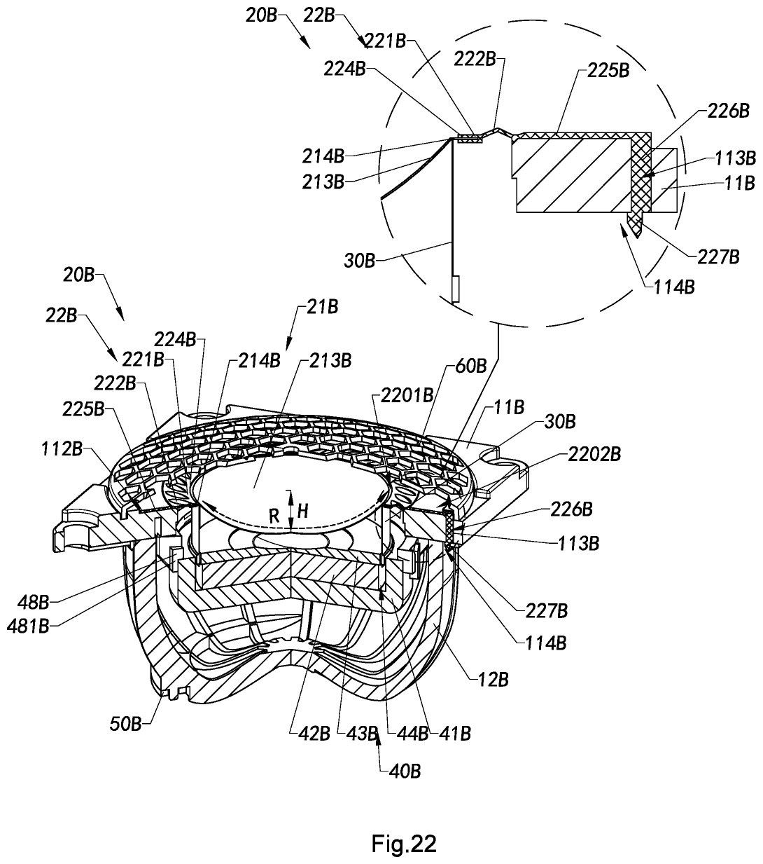

Referring to the FIG. 21 of the drawing, an alternative mode of the tweeter according to the preferred embodiment of the present invention is illustrated, wherein the inverted concave diaphragm 21B further has a diaphragm slot 210B for receiving at least a portion of the inner side connecting edge 224B of the resilient suspension member 22B therein, such that the inner side connecting edge 224B of the resilient suspension member 22B can be more securely coupled to the casing panel 11B. Referring to the FIG. 22 of the drawings, another alternative mode of the tweeter according to the preferred embodiment of the present invention is illustrated, wherein the inner side connecting edge 224B of the resilient suspension member 22B is integrally coupled to the upper and lower surface of the inverted concave diaphragm 21B simultaneously, that is, the inner side connecting edge 224B of the resilient suspension member 22B encapsulates at least a portion of the outer peripheral edge of the inverted concave diaphragm 21B, such that the inner side connecting edge 224B of the resilient suspension member 22B can be more securely coupled to the casing panel 11B, so as to prevent the inner side connecting edge 224B detaching from the inverted concave diaphragm 21B when the inverted concave diaphragm 21B is being driven by the voice coil 30B to vibrate back and forth reciprocatingly along the axial direction of the tweeter, ensuring the reliability of the tweeter when it is in use.

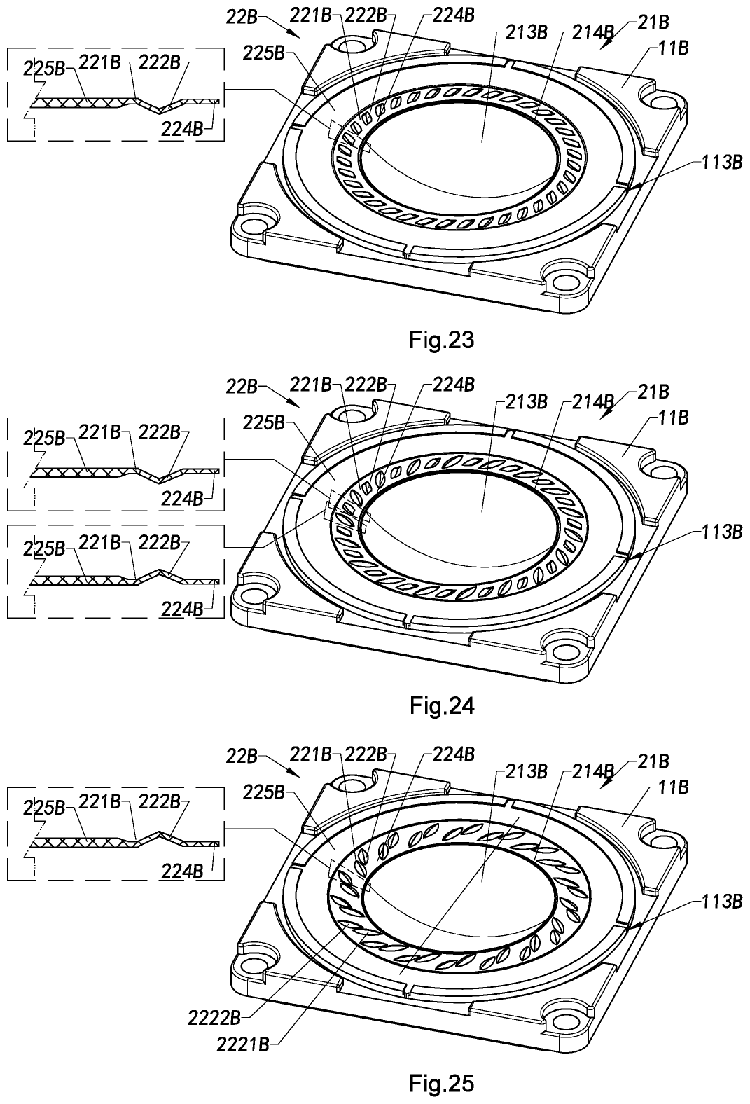

Further, the resilient suspension member 22B comprises a plurality of resilient ribs 222B integrally and intervally provided on the suspension member body 221B, wherein as shown in the embodiment of the FIGS. 12 to 14, the resilient ribs 222B are protruded from the suspension member body 221B and has the same distance between every two resilient ribs 222B. Referring to the FIG. 23 of the drawings, another alternative mode of the tweeter according to the preferred embodiment of the present invention is illustrated, wherein each of the resilient ribs 222B is intended in the suspension member body 221B and has the same distance between every two resilient ribs 222B. Referring to the FIG. 24 of the drawings, another alternative mode of the tweeter according to the preferred embodiment of the present invention is illustrated, wherein the plurality of resilient ribs 222B includes some protruding resilient ribs and some indenting resilient ribs that two protruding resilient ribs 222B are formed at two sides of each indenting resilient rib 222B provided on the suspension member body 221B. Referring to the FIG. 25 of the drawings, another alternative mode of the tweeter according to the preferred embodiment of the present invention is illustrated, wherein the resilient ribs 222B comprises a set of inner resilient ribs 2221B and a set of outer resilient ribs 2222B, wherein each of the inner resilient ribs 2221B is arranged and aligned intevrally and integrally from one side adjacent to the inner side connecting edge 224B to the opposing side adjacent to the outer side connecting edge 225B, while each of the outer resilient ribs 2222B is provided on the side adjacent to the outer side connecting edge 225B to the other side adjacent to the inner side connecting edge 224B. In particular, each of the inner resilient ribs 2221B is formed between two respective adjacent outer resilient ribs 2222B, while each of the outer resilient ribs 2222B is formed between two respective adjacent inner resilient rib 2221B. The purpose of the resilient ribs 222B is to reinforce the rigidity of the resilient suspension member 22B, such that when the inverted concave diaphragm 21B is being driven by the voice coil 30B to vibrate back and forth and the resilient suspension member 22B is deformed simultaneously, if the inverted concave diaphragm 21B has a tendency to deviate to one side, the portion of the resilient suspension member 22B opposing that side will substantially pull the inverted concave diaphragm 21B to prevent the inverted concave diaphragm 21B from inclining towards that side. Accordingly, the resilient suspension member 22B can substantially restrict the inverted concave diaphragm 21B to vibrate merely along the axial direction thereof. Moreover, since the resilient suspension member 22B is reinforced by the resilient rib 222B to restrict the inverted concave diaphragm 21B to strictly move along the axial direction, the conventional centering spider can be eliminated, that enables the tweeter to further reduce its size and broaden its fields of application. For example, the tweeter can be applied in an head-mounted device, such as earphone. In addition, since no centering spider is needed to install in the tweeter of the present invention, the distance between the inner wall of the speaker casing 10B and voice coil 30B can be effectively decreased, so as to effectively prevent the voice coil 30B deviating from the axial direction of the tweeter when it is driving forth and back by the electromagnetic force generated by the magnet unit 40B, and thus preventing the inverted concave diaphragm 21B deviating from the axial direction of the tweeter. Preferably, the resilient ribs 222B of the resilient suspension member 22B can be arranged in a spiral manner to produce a centripetal force towards a central axis of the tweeter for the inverted concave diaphragm 21B, so as to restrict the vibration direction of the inverted concave diaphragm 21B along the axial direction of the tweeter.

It is worth mentioning that the shape of the resilient rib 222B of the resilient suspension member 22B is not intended to be limiting in the present invention. In certain examples, the resilient rib 222BB has a cross section in bow shape, arc shape, triangular, quadrangular, polygonal, semi-circular, semi-elliptical, inverted U shape, inverted V shape, or etc.

It is also worth mentioning that the cross sectional shape of the inner resilient rib 2221B of the resilient suspension member 22B is not intended to be limiting. In certain examples, the suspension member body 221B of the resilient suspension member 22B has a cross section in pleated shape, arc shape, wave shape, or the like.

Furthermore, the inverted concave diaphragm 21B further comprises a concave diaphragm portion 213B and a diaphragm coupling portion 214B integrally and surroundingly provided around a peripheral edge of the concave diaphragm portion 213B. In other words, the diaphragm coupling portion 214B is integrally and outwardly extended from the peripheral edge of the concave diaphragm portion 213B. Preferably, an extension direction of the diaphragm coupling portion 214B is perpendicular to the axial direction of the tweeter. The inner side connecting edge 224B of the resilient suspension member 22B is integrally coupled to the diaphragm coupling portion 214B of the inverted concave diaphragm 21B. It is worth mentioning that the material of the inverted concave diaphragm 21B is not intended to be limiting in the present invention. Preferably, the material of the inverted concave diaphragm 21B is alloy or metal material such as aluminum. In other words, the inverted concave diaphragm 21B is preferably an alloy diaphragm or metallic diaphragm with a satisfied strength and rigidity, such that when the inverted concave diaphragm 21B is being driven by the voice coil 30B, the vibration amplitude of the inverted concave diaphragm 21B at each position is uniform so as to enhance the high-pitch sound effect of the tweeter.

It is worth mentioning that the formation of the inverted concave diaphragm 21B is not intended to be limiting in the present invention. In certain examples, the inverted concave diaphragm 21B may be produced by press molding. More specifically, an alloy or metal plate for making the inverted concave diaphragm 21B is provided, and then a mid-portion of the plate is intended concavely by press molding that, the mid-portion of the plate forms the concave diaphragm portion 213B of the inverted concave diaphragm 21B and a peripheral edge portion of the plate forms the diaphragm coupling portion 214B of the inverted concave diaphragm 21B. In other words, the concave diaphragm portion 213B and the diaphragm coupling portion 214B of the inverted concave diaphragm 21B are made as an integral structure. In other examples, the inverted concave diaphragm 21B may be an injection molded piece produced by injection molding. More specifically, liquid form alloy or metal molding material is filled into a formation mould for producing the inverted concave diaphragm 21B, wherein the liquid form alloy or metal molding material forms the inverted concave diaphragm 21B in the formation mould after it is cured and solidified and the inverted concave diaphragm 21B is obtained after opening the formation mould.

In particular, the inverted concave diaphragm 21B of the tweeter is made to have a size that enables the tweeter to produce a high-pitch voice with a high frequency of 2560 Hz and above, or even a high-pitch sound with an ultra-high frequency of 40 kHz or more. In particular, the inverted concave diaphragm 21B has an arc height H ranging from 5 mm to 7 mm (including the 5 mm and the 7 mm) and a curvature R ranging from 10 mm to 20 mm (including 10 mm and 20 mm).

As verified by an electroacoustic test system, the waveform performance of the tweeter is shown in the FIG. 11 of the drawing, wherein the tweeter is able to produce a high-pitch voice with a high frequency of 2560 Hz or even an ultra-high frequency of 40 kHz, when the inverted concave diaphragm 21B of the tweeter is configured to have an arc height H ranging from 5 mm to 7 mm and a curvature R ranging from 10 mm to 20 mm, which overcomes the technical bias of those who skilled in the art. In other words, the tweeter of the present invention has an unexpected sound effect compared with the conventional tweeters. Accordingly, those skilled in the art believe that only when the conventional vibrating diaphragm of a conventional tweeter is made to protrude at its mid-portion, the conventional tweeter is able to produce a high-pitch sound with a high frequency ranging from 20 kHz to 2560 Hz. However, the inverted concave diaphragm 21B of the present invention is configured to have a concave curved shape with the predetermined parameters of the arc height H and the curvature R in such a manner that the tweeter is enabled to produce a high-pitch sound with a high frequency of 2560 Hz or even a high-pitch sound with an ultra-high frequency of 40 kHz or more, that overcomes the technical bias of those who skilled in the art, thereby the tweeter of the present invention provides unexpected effect over the conventional tweeters.

In addition, the inverted concave diaphragm 21B of the tweeter has a concave shape to converge and gather the high-pitch sound produced by the tweeter of the present invention. In comparison with the conventional tweeter which vibrating diaphragm is made in protruding convex shape, due to the innovative configuration of the inverted concave diaphragm 21B of the present invention, the tweeter of the present invention is able to converge and gather the high-pitch sound so that the high-pitch sound generated from the tweeter can be more concentrated, and thus broadening the application scenario of the tweeter of the present invention. For example, the tweeter disclosed in the present invention can be applied in a head-mounted sound effect device such as headphone.

Moreover, the parameter of the arc height H is preferably ranged from 5.5 mm to 6.5 mm (preferably 6 mm) and the parameter of the curvature R is preferably ranged from 16 mm to 18 mm (preferrably 17 mm).

In addition, the tweeter has a diameter as small as 8 mm (including 8 mm), facilitating the miniaturization of the tweeter. Preferably, the diameter of the tweeter is ranged from 8 mm to 38 mm (including 8 mm and 38 mm). More preferably, the diameter of the tweeter is set from 10 mm to 15 mm (including 10 mm and 15 mm), or 15 mm to 20 mm (including 15 mm and 20 mm), or 20 mm to 30 mm (including 20 mm and 30 mm), or 30 mm to 38 mm (including 30 mm and 38 mm).

In the stage as shown in the FIG. 18 of the drawings, one end of the voice coil 30B is coupled to a lower surface of the concave diaphragm portion 213B of the inverted concave diaphragm 21B. It is worth mentioning that the structure that the voice coil 30B is provided at the lower surface of the concave diaphragm portion 213B of the inverted concave diaphragm 21B is merely exemplary, which is not intended to limit the scope of the present invention.

In the stage as shown in the FIG. 19 of the drawings, a back cover 12B is provided to receive the magnet unit 40B. Specifically, the magnet unit 40B comprises a magnet protective enclosure 41B, a permanent magnet 42B and a magnetizer 43B, wherein the permanent magnet 42B and the magnetizer 43B are disposed in the interior of the magnet protective enclosure 41B at a position that the permanent magnet 42B is retained below the magnetizer 43B, wherein a magnetic gap 44B is formed between the magnet protective enclosure 41B and the permanent magnet 42B for coupling and equipping with the voice coil 30B. The magnet protective enclosure 41B, the permanent magnet 42B and the permanent magnet 42B are incorporated with each other to form a magnetic field loop to interact and equip with the voice coil 30B to drive the voice coil 30B to move forth and back.

It is appreciated that the type of the permanent magnet 42B is not intended to be limiting the present invention. In certain examples, the permanent magnet 42B may be embodied as a magnetic stone, magnetic iron or magnetic steel, such as metal magnets, ferrite magnets rare earth magnets, or etc. In this preferred embodiment of the present invention, the permanent magnet 42B can be embodied as a neodymium iron boron magnet.

In addition, the magnet protective enclosure 41B, the permanent magnet 42B, and the magnetizer 43B of the magnet unit 40B can be connected together by means of adhesion to form a one-piece structure, or be integrally formed by means of injection molding, which is not intended to be limiting in the present invention.

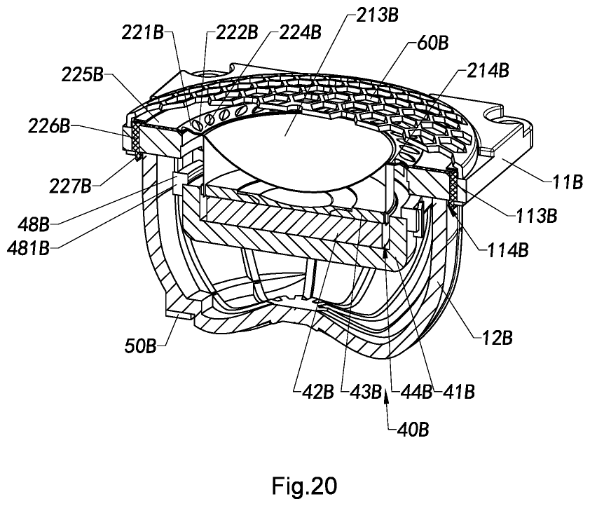

As shown in the FIG. 20 of the drawings, the magnetic loop connecting member 48B is bonded with the casing panel 11B, and the casing panel 11B is bonded with the back cover 12B, such that the magnetic loop connecting member 48B retains the magnet unit 40B between the casing panel 11B and the back cover 12B. More specifically, according to the preferred embodiment of the tweeter as shown in FIGS. 12 to 14 of the drawings, the magnetic loop connecting member 48B has a plurality of positioning slots 483B while the casing panel 11B has a plurality of positioning latches 111B, wherein the positioning latches 111B are inserted and retained in the positioning slots 483B of the magnetic loop connecting member 48B respectively, such that the casing panel 11B is bonded with the magnetic loop connecting member 48B. In addition, the inner wall of each of the positioning slots 483B that defines the positioning slot 483B is adhered with the respective inserted positioning latch 111B. It is worth mentioning that there is no limitation to the manner of bonding the casing panel 11B with the back cover 12B, for example the casing panel 11B can be bonded with the back cover 12B by means of latch and lock assembly, threaded connecting structure, hot welding ultrasonic bonding, or the like.

Moreover, the tweeter further comprises a damping unit 50B provided at the back cover 12B of the speaker casing 10B, wherein when the tweeter is assembled or disposed at a flat surface, the damping unit is adapted for supporting the tweeter at the flat surface and absorbing shocks. In particular, the damping unit 50B is made of resilient or elastic material.

According to the preferred embodiment of the present invention, as shown in the FIGS. 12 to 14 of the drawings, the tweeter further comprises a protective cover 60B, having a plurality of holes therein, wherein the protective cover 60B is provided at the casing panel 11B and retained in a position along the audible wave outputting direction of the vibrating unit 20B, so as to protect the vibrating unit 20B while enhancing the overall aesthetic appearance of the tweeter.

According to another aspect of the present invention, the present invention further provides a manufacturing method of the tweeter as described in the above third preferred embodiment, which comprises the following steps.

(I) Dispose the inverted concave diaphragm 21B and the casing panel 11B in a lower mould 91B of a formation mould 90B with the inverted concave diaphragm 21B being retained at a mid-portion of the ring-shaped casing panel 11B and an annular space 400B being formed between the casing panel 11B and the inverted concave diaphragm 21B. Generally, both the inner wall of the casing panel 11B and the outer wall of the inverted concave diaphragm 21B are in circular shape. Accordingly, according to this preferred embodiment of the present invention, the space 400B defined between the outer wall of the inverted concave diaphragm 21B and the inner wall of the casing panel 11B is in annular shape and the distance between the inner wall of the casing panel 11B and the outer wall of the inverted concave diaphragm 21B is the same.

(II) Form a molding cavity 93B between the lower mould 91B and the upper mould 92B after the lower mould 91B is clamped and closed with an upper mould 92B of the formation mould 90B, wherein at least one gap 300B, communicating with the molding cavity 93B, is formed between at least one portion of the inverted concave diaphragm 21B and the upper mould 92B and/or the lower mould 91B. In other words, the at least one gap 300B is defined between the at least one portion of the inverted concave diaphragm 21B and the upper mould 92B and/or the lower mould 91B, and between at least one portion of the casing panel 11B and the upper mould 92B and/or the lower mould 91B.

For instance, according to the preferred embodiment of the manufacturing process of the tweeter as shown in the in the FIGS. 12 to 14 of the drawings, the at least one gap 300B is formed between at least a portion of the upper surface of the inverted concave diaphragm 21B and the upper mould 92B, and between at least a portion of the upper surface of the casing panel 11B and the upper mould 92B. As shown in FIG. 15 of the drawings, the gaps 300B formed between at least a portion of the upper surface of the inverted concave diaphragm 21B and the upper mould 92B and between at least a portion of the upper surface of the casing panel 11B and the upper mould 92B are communicating with the molding cavity 93B.

(III) Fill a liquid form molding material 100B into the molding cavity 93B and the at least one gap 300B in the formation mould 90B. In the stage as shown in the FIG. 16 of the drawings, when the molding material 100B is filled into the molding cavity 93B, the molding material 100B fills a space 400B formed between the casing panel 11B and the inverted concave diaphragm 21B and then flows and fills the at least one gap 300B between the upper surface of the inverted concave diaphragm 21B and the lower mould 91B and between the upper surface of the casing panel 11B and the upper mould 92B from the space 400B.

(IV) Separate the lower mould 91B and the upper mould 92B of the formation mould 90B with each other after the molding material 100B is cured and solidified, wherein the resilient suspension member 22B integrally coupled to casing panel 11B and the inverted concave diaphragm 21B is formed and fabricated.

(V) Mount one end portion of a voice coil 30B to the lower portion of the inverted concave diaphragm 21B and couple the opposing end of the voice coil 30B with the magnet unit 40B, so that the tweeter of the present invention is produced.

Alternatively speaking, the tweeter according to another aspect of the present invention, the present invention is produced by manufacturing method comprising the steps of:

(i) forming a resilient suspension member 22B by solidifying the liquid form molding material 100B between the inverted concave diaphragm 21B and the casing panel 11B; and

(ii) installing one end portion of a voice coil 30B to the lower portion of the inverted concave diaphragm 21B and coupling and equipping an opposing end portion of the voice coil 30B with the magnet unit 40B to produce the tweeter of the present invention, wherein a concave diaphragm portion 213B of the inverted concave diaphragm 21B has an arc height H ranging from 5 mm to 7 mm (5 mm≤H≤7 mm), and an arc curvature R ranging from 10 mm to 20 mm (10 mm≤R≤20 mm).

According to another aspect of the present invention, the present invention further provides a sound effect reproduction method, which comprises the following steps.

(α) Reciprocatingly moving a voice coil 30B an axial direction of the tweeter by means of an electromagnetic driving force.

(β) Reciprocatingly vibrating an inverted concave diaphragm 21B along the axial direction of the tweeter by the voice coil 30B to agitate air therearound so as to produce and gather sound wave in high frequency, thereby reproducing sound effect.

Preferably, in the step (β), the reciprocating vibration movement of the inverted concave diaphragm 21B is substantially restricted along the axial direction of the tweeter by means of a resilient suspension member 22B which is integrally coupled to the inverted concave diaphragm 21B and a casing panel 11B which is surroundingly and encirclingly provided around a peripheral edge of the inverted concave diaphragm 21B.

According to another aspect of the present invention, the present invention further provides a manufacturing method of a vibrating structure 200B, which comprises the following steps.

(a) Dispose an inverted concave diaphragm 21B and a casing panel 11B in a lower mould 91B of a formation mould 90B, such as an injection formation mould, with the inverted concave diaphragm 21B being retained at a mid-portion of the ring-shaped casing panel 11B and an annular space 400B being formed between the casing panel 11B and the inverted concave diaphragm 21B.

(b) Form a molding cavity 93B between the lower mould 91B and an upper mould 92B of the formation mould 90B after the lower mould 91B is clamped an closed with the upper mould 92B of the formation mould 90B, wherein at least one gap 300B, communicating with the molding cavity 93B, is formed between at least one portion of the inverted concave diaphragm 21B and the upper mould 92B and/or the lower mould 91B. In other words, the at least one gap 300B is defined between the at least one portion of the inverted concave diaphragm 21B and the upper mould 92B and/or the lower mould 91B, and between at least one portion of the casing panel 11B and the upper mould 92B and/or the lower mould 91B.

(c) Fill a liquid form molding material 100B into the molding cavity 93B and the at least one gap 300B in the molding mould 90B.

(d) Separate the lower mould 91B and the upper mould 92B of the formation mould 90B with each other after the molding material 100B is cured and solidified, wherein a resilient suspension member 22B integrally coupled to casing panel 11B and the inverted concave diaphragm 21B is formed and fabricated.

According to another aspect of the present invention, the present invention further provides a manufacturing method of a vibrating structure 200B, comprising the steps of:

(A) guiding the liquid form molding material 100B to cover at least a portion of an outer surface of the casing panel 11B and at least a portion of an outer surface of the inverted concave diaphragm 21B, and filling the annular space 400B formed between an inner side of the casing panel 11B and an outer side of the inverted concave diaphragm 21B.

(B) after the molding material 100B is solidified, forming an outer side connecting edge 225B by the molding material covering the outer surface of the casing panel 11B, an inner side connecting edge 224B by the molding material covering the inverted concave diaphragm 21B, and a suspension member body 221B by the molding material in the annular space 400B, wherein the suspension member body 221B, the outer side connecting edge 225B of the resilient suspension member 22B integrally extended from the suspension member body 221B, and the inner side connecting edge 224B integrally extended from the suspension member body 221B are integrally coupled to the resilient suspension member 22B, to produce the vibrating structure 200B.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-96. (canceled)

97: A tweeter, having no spider and a diameter ranging from 8 mm to 38 mm, comprising:
a speaker casing comprising a casing panel having a ring shape; and
a vibration unit, which comprises an inverted concave diaphragm and a resilient suspension member, wherein said resilient suspension member, having a ring shape, comprises a suspension member body, an inner side connecting edge inwardly and integrally extended from an inner side of said suspension member body and an outer side connecting edge outwardly and integrally extended from an outer side of said suspension member body, wherein said inner side connecting edge of said resilient suspension member is integrally and surroundingly coupled to at least a portion of said inverted concave diaphragm and said outer side connecting edge of said resilient suspension member is integrally coupled to at least a portion of said casing panel, wherein said inverted concave diaphragm has an arc height H ranging from 5 mm to 7 mm and an arc curvature R ranging from 10 mm to 20 mm;
a magnet unit; and
a voice coil, having one end portion coupled to said inverted concave diaphragm coaxially and another end portion coupled and equipped with said magnet unit in such a manner that said voice coil is driven by an electromagnetic driving force generated by said magnet unit to move forth and back reciprocatingly along an axial direction of said voice coil so as to drive said inverted concave diaphragm to vibrate forth and back reciprocating along an axial direction of said inverted concave diaphragm to produce sound in a high frequency of 2560 Hz or above.

98: The tweeter, as recited in claim 97, wherein said inner side connecting edge of said resilient suspension member is molded to integrally and surroundingly couple to said inverted concave diaphragm and said outer side connecting edge of said resilient suspension member is molded to integrally coupled to said casing panel, such that said casing panel, said resilient suspension member and said inverted concave diaphragm form an integral one-piece body.

99: The tweeter, s recited in claim 97, wherein a plurality of resilient ribs is provided intervally and spacedly around said suspension member body of said resilient suspension member for ensuring said inverted concave diaphragm vibrating forth and back along the axial direction thereof.

100: The tweeter, as recited in claim 99, wherein said plurality of resilient ribs is protruded on said suspension member surface of said resilient suspension member.

101: The tweeter, as recited in claim 97, wherein a plurality of protruding resilient ribs and a plurality of indenting resilient ribs are provided intervally and spacedly around said suspension member body of said resilient suspension member in such a manner that each of said protruding resilient ribs is arranged between two of said indenting resilient ribs, so as to said inverted concave diaphragm vibrating forth and back along the axial direction thereof.

102: The tweeter, as recited in claim 97, wherein a set of inner resilient ribs is intervally and spacedly protruded in circular manner on said suspension member body of said resilient suspension member and a set of outer resilient ribs is intervally spacedly protruded in circular manner on said suspension member body of said resilient suspension member, wherein each of said inner resilient ribs is extended in a direction from said inner side connecting edge to said outer side connecting edge, while each of said outer resilient ribs is extended in a direction from said outer side connecting edge to said inner side connecting edge.

103: The tweeter, as recited in claim 102, wherein each of said inner resilient ribs is extended between two of said outer resilient ribs while each of said outer resilient ribs is extended between two of said inner resilient ribs.

104: The tweeter, s recited in claim 98, wherein a plurality of resilient ribs is provided intervally and spacedly around said suspension member body of said resilient suspension member for ensuring said inverted concave diaphragm vibrating forth and back along the axial direction thereof.

105: The tweeter, as recited in claim 104, wherein said plurality of resilient ribs is protruded on said suspension member surface of said resilient suspension member.

106: The tweeter, as recited in claim 98, wherein a plurality of protruding resilient ribs and a plurality of indenting resilient ribs are provided intervally and spacedly around said suspension member body of said resilient suspension member in such a manner that each of said protruding resilient ribs is arranged between two of said indenting resilient ribs, so as to said inverted concave diaphragm vibrating forth and back along the axial direction thereof.

107: The tweeter, as recited in claim 98, wherein a set of inner resilient ribs is intervally and spacedly protruded in circular manner on said suspension member body of said resilient suspension member and a set of outer resilient ribs is intervally spacedly protruded in circular manner on said suspension member body of said resilient suspension member, wherein each of said inner resilient ribs is extended in a direction from said inner side connecting edge to said outer side connecting edge, while each of said outer resilient ribs is extended in a direction from said outer side connecting edge to said inner side connecting edge.

108: The tweeter, as recited in claim 107, wherein each of said inner resilient ribs is extended between two of said outer resilient ribs while each of said outer resilient ribs is extended between two of said inner resilient ribs.

109: The tweeter, as recited in claim 97, wherein said casing panel has an engaging groove and said outer side connecting edge of said resilient suspension member is integrally formed at said engaging groove of said casing panel.

110: The tweeter, as recited in claim 109, wherein said casing panel has one or more engaging through holes communicating with said engaging groove, wherein said resilient suspension member comprises at least one suspension member engaging portion integrally extended from said outer side connecting edge thereof, wherein said suspension member engaging portions are integrally formed at said engaging through holes of said casing panel respectively.

111: The tweeter, as recited claim 110, wherein said casing panel has a retention slot communicating with at least one of said one or more engaging through holes, wherein said resilient member comprises a suspension member retention portion integrally formed with said suspension member engaging portion, wherein said suspension member retention portion is formed in said retention slot of said casing panel.

112: The tweeter, as recited in claim 99, wherein said casing panel has an engaging groove and said outer side connecting edge of said resilient suspension member is integrally formed at said engaging groove of said casing panel.

113: The tweeter, as recited in claim 112, wherein said casing panel has one or more engaging through holes communicating with said engaging groove, wherein said resilient suspension member comprises at least one suspension member engaging portion integrally extended from said outer side connecting edge thereof, wherein said suspension member engaging portions are integrally formed at said engaging through holes of said casing panel respectively.

114: The tweeter, as recited claim 113, wherein said casing panel has a retention slot communicating with at least one of said one or more engaging through holes, wherein said resilient member comprises a suspension member retention portion integrally formed with said suspension member engaging portion, wherein said suspension member retention portion is formed in said retention slot of said casing panel.

115: The tweeter, as recited in claim 101, wherein said casing panel has an engaging groove and said outer side connecting edge of said resilient suspension member is integrally formed at said engaging groove of said casing panel.

116: The tweeter, as recited in claim 115, wherein said casing panel has one or more engaging through holes communicating with said engaging groove, wherein said resilient suspension member comprises at least one suspension member engaging portion integrally extended from said outer side connecting edge thereof, wherein said suspension member engaging portions are integrally formed at said engaging through holes of said casing panel respectively.

117: The tweeter, as recited claim 116, wherein said casing panel has a retention slot communicating with at least one of said one or more engaging through holes, wherein said resilient member comprises a suspension member retention portion integrally formed with said suspension member engaging portion, wherein said suspension member retention portion is formed in said retention slot of said casing panel.

118: Tweeter, as recited in claim 101, wherein said casing panel has an engaging groove and said outer side connecting edge of said resilient suspension member is integrally formed at said engaging groove of said casing panel.

119: The tweeter, as recited in claim 118, wherein said casing panel has one or more engaging through holes communicating with said engaging groove, wherein said resilient suspension member comprises at least one suspension member engaging portion integrally extended from said outer side connecting edge thereof, wherein said suspension member engaging portions are integrally formed at said engaging through holes of said casing panel respectively.

120: The tweeter, as recited claim 119, wherein said casing panel has a retention slot communicating with at least one of said one or more engaging through holes, wherein said resilient member comprises a suspension member retention portion integrally formed with said suspension member engaging portion, wherein said suspension member retention portion is formed in said retention slot of said casing panel.

121: The tweeter, as recited in claim 97, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

122: The tweeter, as recited in claim 97, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

123: The tweeter, as recited in claim 99, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

124: The tweeter, as recited in claim 99, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

125: The tweeter, as recited in claim 102, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

126: The tweeter, as recited in claim 102, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

127: The tweeter, as recited in claim 104, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

128: The tweeter, as recited in claim 104, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

129: The tweeter, as recited in claim 114, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

130: The tweeter, as recited in claim 114, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

131: The tweeter, as recited in claim 117, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

132: The tweeter, as recited in claim 117, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

133: The tweeter, as recited in claim 120, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 10 mm to 15 mm (10 mm≤R≤15 mm).

134: The tweeter, as recited in claim 120, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is ranged from 15 mm to 20 mm (15 mm≤R≤20 mm).

135: A tweeter, having no spider, comprising:
a speaker casing comprising a casing panel having a ring shape; and
a vibration unit, which comprises:
an inverted concave diaphragm having a concave shape and having an arc height H ranging from 5 mm to 7 mm and an arc curvature R ranging from 10 mm to 20 mm, wherein said casing panel is arranged surrounding said inverted concave diaphragm, and
a ring-shaped resilient suspension member integrally molded between said casing panel and said inverted concave diaphragm for ensuring said inverted concave diaphragm to be vibrating forth and back reciprocatingly along an axial direction thereof;
a magnet unit; and
a voice coil, having one end portion coupled to said inverted concave diaphragm coaxially and another end portion coupled and equipped with said magnet unit in such a manner that said voice coil is driven by an electromagnetic driving force generated by said magnet unit to move forth and back reciprocatingly along an axial direction of said voice coil so as to drive said inverted concave diaphragm to vibrate forth and back reciprocatingly along said axial direction of said inverted concave diaphragm to produce sound in a high frequency of 2560 Hz or above.

136: The tweeter, as recited in claim 135, wherein said arc height H of said concave diaphragm portion of said inverted concave diaphragm is ranged from 5.5 mm to 6.5 mm (5.5 mm≤H≤6.5 mm), and said arc curvature R of said concave diaphragm portion of said inverted concave diaphragm is selectively ranged from 10 mm to 15 mm (10 mm≤R≤15 mm) or from 15 mm to 20 mm (15 mm≤R≤20 mm).
